(19) United States
(12) Patent Application Publication
(10) Pub. No.: US 2025/0384685 A1
(43) Pub. Date: Dec. 18, 2025

(54) PLATFORM FOR ENVIRONMENTAL CONSULTING, ASSESSMENT, MONITORING, REPORTING, AND PREDICTION

(71) Applicant: Ecobot, Inc., Asheville, NC (US)

(72) Inventors: Lee Lance, Asheville, NC (US); Christopher McGovern, Asheville, NC (US)

(73) Assignee: Ecobot, Inc., Asheville, NC (US)

(21) Appl. No.: 19/228,141

(22) Filed: Jun. 4, 2025

Related U.S. Application Data
(60) Provisional application No. 63/659,626, filed on Jun. 13, 2024.

(51) Int. Cl. G06V 20/10; G06F 16/538; G06Q 50/02; G06T 11/00; G06V 10/75; G06V 20/13

(52) U.S. Cl. CPC G06V 20/188; G06F 16/538; G06T 11/00; G06V 10/75; G06V 20/13; G06Q 50/02; G06T 2200/24

(57) ABSTRACT

A data collection and data management platform for environmental consulting provides for recording, reporting, analyzing and predicting the environmental impact and potential land use risk and opportunity of projects. The platform provides for collected data to be uploaded to a database and accessed for editing, manipulating, assigning, and managing the collected data. The platform is operable to be utilized for environmental evaluation and consulting, and more specifically for wetland determination, including wetland delineation, as well as stream identification, and natural resource and habitat monitoring. The platform provides for analyzing data and uses an artificial intelligence engine to monitor, predict, and support land use risk and biodiversity impact.

### CROSS REFERENCES TO RELATED APPLICATIONS

This application claims priority to and the benefit of U.S. Provisional Patent Application No. 63/659,626, filed Jun. 13, 2024, which is incorporated herein by reference in its entirety.

### BACKGROUND OF THE INVENTION

### 1. Field of the Invention

The present invention relates to a platform for environmental evaluation and consulting, specifically to a platform for environmental and natural resource identification, assessment and monitoring, including stream identification, rare, threatened and endangered species monitoring, wetland determination and delineation, and more specifically to a platform for environmental evaluation that collects, anonymizes, stores, and analyzes data using an artificial intelligence engine to monitor and predict land use risk and biodiversity impact.

### 2. Description of the Prior Art

It is generally known in the prior art to provide platforms for environmental evaluation.

Prior art patent documents include the following:

US Patent Pub. No. 2020/0272625 for Platform and method for evaluating, exploring, monitoring and predicting the status of regions of the planet through time by inventors Brumby et al., filed Feb. 21, 2020 and published Aug. 27, 2020, is directed to a platform and method for evaluating, exploring, and predicting the status of regions of the planet through time. The method is a computer-implemented means for evaluating an area. The method includes collecting relevant datasets, transforming datasets into dynamic datasets, selecting a region of interest, selecting factors of interest, producing an evaluation index for the region of interest, specifying targets and thresholds for the evaluation index, generating a visualization of the evaluation index for the region of interest; generating alerts when the evaluation index changes in specified ways, and reporting the status and trend of the region of interest using the evaluation index. The data transformation is optionally achieved with machine learning algorithms and training data to produce time series indices. The method may also produce predictive models and maps from the time series indices.

US Patent Pub. No. 2021/0133629 for Coastal Aquatic Conditions Reporting System Using A Learning Engine by inventors Beavers et al., filed Oct. 25, 2020 and published May 6, 2021, is directed to a software system that incorporates a digital learning engine comprised of machine learning algorithms that efficiently speeds up and expands the extraction of practically useful information from massively large data sets of observations and measurements of coastal aquatic environmental and human health conditions for the purpose of planning and implementing sustainable, preventative or mitigation actions by commercial, consumer, citizen, government, and research organizations.

US Patent Pub. No. 2022/0405590 for Machine learning models for automated sustainability data source ingestion and processing by inventor Hebets, filed Jun. 15, 2022 and published Dec. 22, 2022, is directed to a computerized method for automated sustainability data source ingestion and processing includes searching multiple data sources according to specified data ingestion criteria to obtain sustainability data associated with at least one target entity, and supplying the target entity and the obtained sustainability data to a machine learning model to generate a sustainability data source valuation output for each of the multiple data sources. The method includes determining, for each of multiple categories and subcategories, a valuation score based at least in part on one or more of the sustainability data source valuation outputs, and an entity sustainability score based at least in part on one or more of the valuation scores. The method includes determining an overall entity sustainability score associated with the at least one target entity according to the determined entity sustainability scores for the multiple categories and subcategories.

U.S. Pat. No. 7,353,113 for System, method and computer program product for aquatic environment assessment by inventors Sprague et al., filed Dec. 7, 2004 and issued Apr. 1, 2008, is directed to a system, method and computer program product for assessing aquatic environments. Initially, the user measures biological, geomorphological and physiological parameters, quantitatively, semi-quantitatively and qualitatively in the field, guided by the computer software, and enters the data obtained from such measurements entered into a handheld computer processing means running the computer software of the present invention. Then, the data is transferred into a desktop computer processing means for automated analysis, processing, reporting of field data, and production of various user reports through the synchronized, compatible desktop software.

WO Patent Pub. No. 2011/072467 for Method and system for monitoring of wetlands resource and ecological environment by inventor Zhao et al., filed Jan. 25, 2010 and published Jun. 23, 2011, is directed to a method and system for monitoring of wetlands resource and ecological environment. The system is composed of four parts: management system of wetlands space data, investigation system of wetlands field, management system of wetlands events, protection website of wetlands. Data is transferred by using communication ways of internet, 3G network, wireless communication network. A common database worked as information hub connects said four parts. Core part of the system for monitoring of wetlands resource and ecological environment is management system of wetlands space data, which is developed by using B/S+C/S mixed mode. The investigation system of wetlands field developed by portable computer and GPS module is used for investigation in wetlands field as well as acquisition and updating of data; Management system of wetlands events enables dynamic monitoring of wetlands ecological events by using mobile GIS technology, SMS Gateway, SMS central platform hardware and technology; Protection website of wetlands developed by using WebGIS technology is a window of communication, which can release wetlands space information and propagate wetlands culture to public.

U.S. Pat. No. 11,172,045 for Spatio-temporal data processing systems and methods by inventors Karpistsenko et al., filed Jul. 2, 2019 and issued Nov. 9, 2021, is directed to systems and methods for collecting, integrating, processing, distributing, and analyzing spatial and/or spatio-temporal information associated with a variety of data sources and/or locations. In some embodiments, systems and methods described herein allow for collection and integration of information included in one or more spatial and/or spatio-temporal data streams and/or other related information that may be utilized in connection with one or more analytical processes. In certain embodiments, the disclosed embodiments may allow a user to, among other things, interact with spatio-temporal information associated with a variety of diverse data sources, generate visualizations using such data, and/or perform desired analytical queries based on the data.

US Patent Pub. No. 2021/0041406 for Networked Environmental Monitoring System and Method by inventors Zeng, filed Oct. 11, 2020 and published Feb. 11, 2021, is directed to a system and method for monitoring environment employ a dense network of sensor nodes. The method includes obtaining environmental information by combining a plurality of observations; wherein the plurality of observations are made with in-situ sensors and remote sensors; wherein the sensors form a high-density network comprising a plurality of distributed sensors; and wherein an individual sensor node, comprising of one or more sensors, can perform automatic zero-drift or other correction by deriving calibration information from other nearby nodes' observational data. The system can monitor gas concentrations over urban areas, industrial, forest, farm, wetland, power plants and other types of surfaces.

U.S. Pat. No. 7,536,025 for Process, system, or method for the determination of the percentage of area of a parcel of land available for development or preservation and the production of a report and map therefor on a fixed tangible medium by inventors Folchetti at al., filed Jun. 23, 2005 and issued May 2019, 2019 is directed to a system for the determination of the percentage of area of a parcel of land available for development or preservation which comprises at least one privately gathered data base having at least one file relating to at least one geographic area and its privately gathered corresponding map, physical, geographic, geologic, edaphic, and flora parameters present in and relating to said geographic area; a Software Decision Control Framework connected to the privately gathered data base; a Geographic Information System connected to and interacting with both the Software Decision Control Framework and the privately gathered data base; a network connected and interfaced to the Software Decision Control Framework and at least one data base interfaced with the network, the data base comprising physical, geographic, geologic, edaphic and flora parameters present in and relating to various geographic areas worldwide, whereby the Software Decision Control Framework interacts with the privately gathered data base, the Geographic Information System, the network and the database to provide an evaluation report which identifies, quantifies and establishes the percentage of area of the parcel of land for development and preservation in conformance to local, federal and state land use regulations and non-governmental land use policies.

U.S. Pat. No. 11,842,537 for Devices, methods, and graphical user interfaces for analyzing, labeling, and managing land in a geospatial platform by inventors Jain et al., filed Dec. 30, 2022 and issued Dec. 12, 2023, is directed to example systems, methods, and non-transitory computer readable media directed to determining a geographic location to be assessed; obtaining information associated with the geographic location, the information including at least one data point of the geographic location; classifying one or more habitats within the geographic location based on at least one machine learning model that processes the at least one data point of the geographic location; determining at least one respective metric for the one or more classified habitats based at least in part on the at least one data point of the geographic location; and providing an interface that includes at least a map of the geographic location and the at least one respective metric for the one or more classified habitats, the one or more classified habitats are visually segmented in the map by habitat type.

U.S. Pat. No. 7,681,531 for System for assessing habitat value by inventor O'Neil, filed on Feb. 21, 2007 and issued on Mar. 23, 2010, is directed to a system for quantifying or assigning values to habitats and/or species occurring within a geographic site. In one implementation, for example, a baseline habitat value is assigned to a geographic site prior to the performance of a proposed activity impacting the site, such as development or construction. The baseline habitat value is based at least in part on the specific types of habitats found in the site, the number of species found in the site, and the key ecological functions associated with each species.

The baseline habitat value can be adjusted to account for the potential presence of invasive plant species within the site. A future habitat value for the site following the performance of the activity also can be determined. A debit value associated with the proposed activity can be determined by subtracting the future habitat value from the baseline habitat value.

US Patent Pub. No. 2010/0070320 for Accounting tool for measuring ecosystem service functional performance at a particular site by inventors Halsey et al., filed Sep. 10, 2009 and published Mar. 18, 2010, is directed to An accounting method to measure ecological value (or measurement of functional performance) of a particular site that divides the site into individual map units as determined by the number of substantially homogenous habitats found at the site. Habitat functions are determined per individual map unit. Performance indicators, such as habitat structures, physical and biological features, and other components, are identified and collected according to predefined ranges in the field or from actual site data. The values of performance indicators are assessed or scored based on collected data using look-up tables to create an indicator of functional performance. The indicator of functional performance is inputted into formulas to derive a measurement of functional performance at the individual map unit and the overall site. The accounting method of the present invention can also calculate ecological change at a particular site by calculating initial or baseline site values and a projected future value based on a particular projected modification (e.g., restoration or development) at the site and effects the modification may have over a period of time (e.g., 20 years). The difference between the future and the baseline values, whether a credit (uplift) or debit (impact or site degradation), can then be used in diverse applications, such as mitigation banking, ecological exchanges, registries, or as part of business or government decision/policy making.

U.S. Pat. No. 9,390,331 for System and method for assessing riparian habitats by inventors Sant et al., filed Apr. 14, 2015 and issued Jul. 12, 2016, is directed to a method of assessing a riparian area includes mapping a physical extent of a potential riparian area (PRA) along a stream using first imagery, determining a percent of basic functional groups of vegetation with the PRA using the first imagery, and determining a Normalized Difference Vegetation Index (NDVI) for the PRA over multiple years using second imagery. The method further includes setting an NDVI threshold value for riparian vegetation in the PRA using the NDVI, mathematically relating the percent of basic functional groups with the NDVI threshold value to evaluate and correct the NDVI threshold value, and determining a proper function and condition (PFC) assessment of the PRA using the corrected NDVI threshold value.

U.S. Pat. No. 10,096,154 for Localized contour tree method for deriving geometric and topological properties of complex surface depressions based on high resolution topographical data by inventors Liu et al., filed Apr. 4, 2017 and issued Oct. 9, 2018, is directed to computer-implemented methods for detecting and characterizing surface depressions in a topographical landscape based on processing of high resolution digital elevation model data according to a local tree contour algorithm applied to an elevation contour representation of the landscape, and characterizing the detected surface depressions according to morphometric threshold values derived from data relevant to surface depressions of the topographical area. Non-transitory computer readable media comprising computer-executable instructions for carrying out the methods are also provided.

U.S. Pat. No. 8,655,791 for Method and apparatus for generating standardized environmental benefit credits by inventor Zimmerman, filed Mar. 10, 2008 and issued Feb. 18, 2014, is directed to a method and apparatus for determining standardized environmental attributes is disclosed, including a method and apparatus for generating and quantifying standardized carbon emission reduction credits. General data and site-specific data, if available, are input into a suitable model to determine the approximate change in the environmental attribute as a result of a human-caused change. An uncertainty analysis is conducted on the results to quantify and normalize the environmental attribute. Standardized environmental attributes may be compiled for trade and other standardized environmental attributes are placed in reserve.

US Patent Pub. No. 2017/0046804 for Method and system for creating an enduring habitat by inventor Slay, filed Oct. 28, 2016 and published Feb. 16, 2017, is directed to a system for mitigating the loss of a species is disclosed. The system may have a digging implement to move earth in order to create a mitigation habitat on a mitigation property. The mitigation property being located on real property where Native American artifacts or remains are buried. Creating the habitat may include removing invasive species, importing species into the habitat, modifying the water system on the property, erecting fences, building a cultural center, and/or creating walkways, for example.

### SUMMARY OF THE INVENTION

The present invention relates to a platform for cataloging multiple data points related to natural resources, aquatic resources, rare, threatened and endangered species, vegetation, soil, hydrology, wetland determination, stream identification and mitigation banking and managing the collection and distribution of the data. The platform of the present invention is operable to be accessed by both a mobile application for data collection and a desktop web application for management of collected data. The present invention provides for the analysis of stored datasets using deep-learning artificial intelligence (AI), wherein the stored datasets provide an expert network learning layer (ENLL).

It is an object of this invention to decrease the amount of time necessary for the process of natural resources assessment, including stream identification and wetland delineation and establishment and monitoring of conserved and/or restored lands, including mitigation banks while increasing the accuracy of data collection and preventing the accidental override or erasure of data points. The present invention tracks, identifies, logs, and predicts the biodiversity of environmental sites, thereby identifying new locations suitable for conservation, restoration, habitat construction and mitigation banking. It is an object of the present invention to provide a system and platform for collection of ground truth data and analysis of the collected data using deep-learning AI to generate insights that model and predict biodiversity development, support resource management, and enable the measurement and management of natural capital credits and baseline and monitoring field data.

In one embodiment, the present invention is directed to a system for wetland delineation, stream identification, and natural resource and habitat monitoring, including a server platform in network communication with one or more user devices, wherein the server platform is operable to receive data points from the one or more user devices, and wherein the data points include geolocation data for where each data point was collected, wherein the data points further include information regarding vegetation, soil, and/or streams proximate to the data points, wherein the server platform is operable to receive one or more images of vegetation associated with one or more of the data points and utilize artificial intelligence-based matching to identify one or more species of plants in the one or more images of vegetation, wherein the server platform is operable to generate one or more polygons delineating a wetland area based on connecting three or more of the data points, wherein the server platform is configured to generate a map interface to display on the one or more user devices based on satellite imagery data for an area, and wherein the server platform is configured to overlay the data points and/or the one or more polygons on the map interface for the area.

In another embodiment, the present invention is directed to a method for wetland delineation, including a server platform communicating with one or more user devices, the server platform receiving data points from the one or more user devices, wherein the data points include geolocation data for where each data point was collected, the data points further including information regarding vegetation, soil, and/or streams proximate to the data points, the server platform receiving one or more images of vegetation associated with one or more of the data points and utilizing artificial intelligence-based matching to identify one or more species of plants in the one or more images of vegetation, the server platform generating one or more polygons delineating a wetland area based on connecting three or more of the data points, the server platform generating a map interface to display on the one or more user devices based on satellite imagery data for an area, and the server platform overlaying the data points and/or the one or more polygons on the map interface for the area.

In yet another embodiment, the present invention is directed to a system for wetland delineation, including a server platform in network communication with one or more user devices, wherein the server platform is operable to receive data points from the one or more user devices, and wherein the data points include geolocation data for where each data point was collected, wherein the data points further include information regarding vegetation, soil, and/or streams proximate to the data points, wherein the server platform is operable to receive one or more images of vegetation associated with one or more of the data points and utilize artificial intelligence-based matching to identify one or more species of plants in the one or more images of vegetation, wherein the server platform is operable to generate one or more polygons delineating a wetland area based on connecting three or more of the data points, and wherein the server platform utilizes an artificial intelligence-based generation module to automatically generate one or more reports for the wetland area based on the data points associated with the wetland area.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a graphical user interface (GUI) of the data collection functionality of the platform according to one embodiment of the present invention.

FIG. 2 illustrates a GUI of the data collection functionality of the platform according to one embodiment of the present invention.

FIG. 3 illustrates a GUI of the data collection functionality of the platform according to one embodiment of the present invention.

FIG. 4A illustrates a GUI of the data collection functionality of the platform according to one embodiment of the present invention.

FIG. 4B illustrates a GUI of the data collection functionality of the platform according to one embodiment of the present invention.

FIG. 4C illustrates a GUI of the data collection functionality of the platform according to one embodiment of the present invention.

FIG. 5 illustrates a GUI of the data collection functionality of the platform according to one embodiment of the present invention.

FIG. 6A illustrates a GUI of the data collection functionality of the platform according to one embodiment of the present invention.

FIG. 6B illustrates a GUI of the data collection functionality of the platform according to one embodiment of the present invention.

FIG. 6C illustrates a GUI of the data collection functionality of the platform according to one embodiment of the present invention.

FIG. 6D illustrates a GUI of the data collection functionality of the platform according to one embodiment of the present invention.

FIG. 7 illustrates a GUI of the data collection functionality of the platform according to one embodiment of the present invention.

FIG. 8 illustrates a GUI of the data collection functionality of the platform according to one embodiment of the present invention.

FIG. 9 illustrates a GUI of the data collection functionality of the platform according to one embodiment of the present invention.

FIG. 10 illustrates a GUI of the data collection functionality of the platform according to one embodiment of the present invention.

FIG. 11 illustrates a GUI of the data collection functionality of the platform according to one embodiment of the present invention.

FIG. 12 illustrates a GUI of the data collection functionality of the platform according to one embodiment of the present invention.

FIG. 13 illustrates a GUI of the data collection functionality of the platform according to one embodiment of the present invention.

FIG. 14 illustrates a GUI of the data management functionality of the platform according to one embodiment of the present invention.

FIG. 15 illustrates a GUI of the data management functionality of the platform according to one embodiment of the present invention.

FIG. 16 illustrates a GUI of the data management functionality of the platform according to one embodiment of the present invention.

FIG. 17A illustrates a GUI of the data management functionality of the platform according to one embodiment of the present invention.

FIG. 17B illustrates a GUI of the data management functionality of the platform according to one embodiment of the present invention.

FIG. 19A illustrates a GUI of the data management functionality of the platform according to one embodiment of the present invention.

FIG. 19B illustrates a GUI of the data management functionality of the platform according to one embodiment of the present invention.

FIG. 20A illustrates a GUI of the data management functionality of the platform according to one embodiment of the present invention.

FIG. 20B illustrates a GUI of the data management functionality of the platform according to one embodiment of the present invention.

FIG. 21A illustrates a GUI of the data management functionality of the platform according to one embodiment of the present invention.

FIG. 21B illustrates a GUI of the data management functionality of the platform according to one embodiment of the present invention.

FIG. 22 illustrates a GUI of the data management functionality of the platform according to one embodiment of the present invention.

FIG. 23 illustrates a GUI of the data management functionality of the platform according to one embodiment of the present invention.

FIG. 24 illustrates a GUI of the data management functionality of the platform according to one embodiment of the present invention.

FIG. 25 illustrates a GUI of the data management functionality of the platform according to one embodiment of the present invention.

FIG. 26 illustrates a GUI of the data management functionality of the platform according to one embodiment of the present invention.

FIG. 27 illustrates a GUI of the data management functionality of the platform according to one embodiment of the present invention.

FIG. 28 illustrates a GUI of the data management functionality of the platform according to one embodiment of the present invention.

FIG. 29 illustrates a GUI of the data management functionality of the platform according to one embodiment of the present invention.

FIG. 30 illustrates a GUI of the data management functionality of the platform according to one embodiment of the present invention.

FIG. 31 illustrates a schematic diagram of a system of the present invention.

### DETAILED DESCRIPTION

The present invention relates to a platform for cataloging multiple data points related to natural resources, aquatic resources, rare, threatened and endangered species, vegetation, soil, hydrology, wetland determination, stream identification and mitigation banking and managing the collection and distribution of the data. The platform of the present invention is operable to be accessed by both a mobile application for data collection and a desktop web application for management of collected data. The present invention provides for the analysis of stored datasets using deep-learning artificial intelligence (AI), wherein the stored datasets provide an expert network learning layer (ENLL).

In one embodiment, the present invention is directed to a system for wetland delineation, including a server platform in network communication with one or more user devices, wherein the server platform is operable to receive data points from the one or more user devices, and wherein the data points include geolocation data for where each data point was collected, wherein the data points further include information regarding vegetation, soil, and/or streams proximate to the data points, wherein the server platform is operable to receive one or more images of vegetation associated with one or more of the data points and utilize artificial intelligence-based matching to identify one or more species of plants in the one or more images of vegetation, wherein the server platform is operable to generate one or more polygons delineating a wetland area based on connecting three or more of the data points, wherein the server platform is configured to generate a map interface to display on the one or more user devices based on satellite imagery data for an area, and wherein the server platform is configured to overlay the data points and/or the one or more polygons on the map interface for the area.

In another embodiment, the present invention is directed to a method for wetland delineation, including a server platform communicating with one or more user devices, the server platform receiving data points from the one or more user devices, wherein the data points include geolocation data for where each data point was collected, the data points further including information regarding vegetation, soil, and/or streams proximate to the data points, the server platform receiving one or more images of vegetation associated with one or more of the data points and utilizing artificial intelligence-based matching to identify one or more species of plants in the one or more images of vegetation, the server platform generating one or more polygons delineating a wetland area based on connecting three or more of the data points, the server platform generating a map interface to display on the one or more user devices based on satellite imagery data for an area, and the server platform overlaying the data points and/or the one or more polygons on the map interface for the area.

In yet another embodiment, the present invention is directed to a system for wetland delineation, including a server platform in network communication with one or more user devices, wherein the server platform is operable to receive data points from the one or more user devices, and wherein the data points include geolocation data for where each data point was collected, wherein the data points further include information regarding vegetation, soil, and/or streams proximate to the data points, wherein the server platform is operable to receive one or more images of vegetation associated with one or more of the data points and utilize artificial intelligence-based matching to identify one or more species of plants in the one or more images of vegetation, wherein the server platform is operable to generate one or more polygons delineating a wetland area based on connecting three or more of the data points, and wherein the server platform utilizes an artificial intelligence-based generation module to automatically generate one or more reports for the wetland area based on the data points associated with the wetland area.

None of the prior art discloses a predictive analytics platform for tracking and predicting the biodiversity of environmental sites, including a data collection and data management platform, a data library for extensive data normalization, and custom mapping functionality with multiple geographical positioning systems (GPS), the data from which is analyzed by a deep-learning AI engine for the generation of dynamic, predictive outputs and insights.

Biodiversity is the key to climate resilience and a leading indicator of climate change impact. As biodiversity decreases, the impact of climate change becomes increasingly apparent. As a result, there is a global initiative to maintain and even restore biodiversity to a previous standard. To accomplish this goal, many countries have implemented biodiversity and sustainability initiatives to monitor and reduce the impact that large corporations have on biodiversity and surrounding ecosystems. Large corporations are increasingly required by various national and international legislation to monitor, report, and even reduce their impact on biodiversity. For companies with business in the EU, the EU Corporate Sustainability Reporting Directive (CSRD) mandates the disclosure of changes in spatial configuration of ecosystems, as well as changes in structural and functional connectivity. The CSRD also mandates the disclosure of measures taken to prevent the spread of invasive species and the risks posed by such invasive species, and changes in the habitats of native species. While the CSRD is a mandatory directive, the voluntary Taskforce for Nature-related Financial Disclosures (TNFD) guides organizations globally in reporting on nature-related risks and opportunities, with a particular focus on redirecting financial flows toward nature-positive outcomes. The TNFD framework includes the reporting of ecosystem restoration over time, the management and sustainable management practices for an ecosystem, and the pressures present in a specific ecosystem. When reporting under both the TNFD and the CSRD, the metrics observed are expanding significantly to include conversions (not just restoration) of an ecosystem over time, changes in management practices, any biodiversity-sensitive sites, the type and extent of the ecosystem and the condition of the ecosystem relative to the reference state, management of introduction of invasive species, and the threatened species, threat risk, population size, and extinction risk for natural species. See Lombardo, S., O'Shea, T., Rosenthal, A., et al. (2024). Accelerating Biodiversity and Ecosystem Reporting [White Paper]. Planet Labs PBC., which is incorporated herein by reference in its entirety.

This data must be collected for each ecosystem impacted by a company. However, the current system for collecting biodiversity data relies on independent researchers and contractors to collect field samples and data for the purpose of analysis and evaluation. This independent commissioning and contracting system is expensive and time consuming. Additionally, this data collection is often limited to only one area of interest, narrowing the relevancy of the results of such testing analysis to only a narrow environmental sampling area. Some systems attempt to reconcile this expense by incorporating sensor data and satellite image analysis into biodiversity information, without conducting field work and collecting ground truth data. Outdated data and proprietary data silos further constrict the use of the collected information. See Hahn, N. R., Bombaci, S. P. & Wittemyer, G. Identifying conservation technology needs, barriers, and opportunities. Sci Rep 12, 4802 (2022). DOI: 10.1038/s41598-022-08330-w, which is incorporated herein by reference in its entirety.

There is a longstanding, unmet need to provide for a platform which provides tools for analyzing and predicting the effects of development and construction on ecosystems and the climate more generally. The present invention solves this longstanding unmet need by providing tools for climate change mitigation. By providing detailed information regarding ecosystems that is updated over time and compared with data for other ecosystems, the present invention provides for identification of key environmental resources and biodiversity, providing for the impact on these resources and plants/animals to be predicted and mitigated. The platform accordingly provides for reducing additional greenhouse gas emissions or removing greenhouse gases already present in the atmosphere by identifying and preserving ecosystems which should be maintained or managed to absorb greenhouse gases or prevent additional greenhouse gas emissions. The regulatory-based natural resources data provides information for planners and civil engineers to make decisions about the environmental impact of planned projects and to mitigate environmental impact as projects are planned and executed. This information is made available to the rest of the construction workflow as well, providing georeferenced data and a deeper understanding of the environmental resources and environmental impact of projects.

The present invention provides a system for incorporating the ground truth data collected for the purpose of environmental evaluation, anonymizing the data, storing the data, and incorporating the data into a deep-learning AI engine for evaluating the impact of various factors on biodiversity trends. Environmental evaluation is a multilevel undertaking, often spanning several states and requiring a multitude of data points. The standard organizational tactics for handling physical reports are not feasible at larger scales, and do not provide for the data analysis and insights provided by the platform of the present invention. As the number of data points increase for a given project, more physical reports are required and must be cataloged. The organization of reports for multistate, multiregional, and/or interstate projects becomes convoluted and time consuming. Additionally, the division between independent, private permitting systems for data collection prevents the development of a global biodiversity database. Thus, there is a long felt, unmet need for a platform capable of coordinating the collection and management of data points for an environmental evaluation and permitting project, which is then configured to analyze the data and incorporate the data into biodiversity data sets for further analysis and predictive modeling. The platform includes location-specific data derived in conjunction with location sensing hardware such as GPS or Global Navigation Satellite System (GNSS) enabled hardware, research databases for streamlining hydrology, vegetation, and soil analysis, and administrative functionality to allow for project management, data collection delegation, and other administrative tasks, as well as anonymizing and storing the collected data for access by a deep-learning AI engine.

The present invention has successfully met the long felt needs where others have failed. Specifically, the present invention provides multiple improvements upon the platforms of the prior art within the field. Some platforms, such as the platform of Brumby et al., disclosed in US Patent Pub. No. 2020/0272625, does not provide for incorporation of prompts for streamlining the collection of hydrology, vegetation, and soil data, as well as administrative functionality which allows for the management, delegation, and submission of environmental data for regulatory permitting. Other systems, such as the system of Beavers et al., disclosed in US Patent Pub. No. 2021/0133629, are limited in the type and application of datasets collected. Specifically, Beavers et al. is limited to coastal aquatic habitats for data collection and analysis.

While the present invention is discussed primarily with respect to wetland determination and wetland delineation embodiments, the platform of the present invention is operable to be utilized for any type of environmental consulting or fieldwork. Specifically, the data collection and data analysis functionality described in the present application is operable to be utilized for collecting and analyzing data relating to natural resources, vegetation analysis, soil analysis, groundwater monitoring, environmental remediation, mitigation banking, mammalian species, aquatic species, organic material analysis, biodiversity credits, carbon footprint, forest surveys, threatened and endangered species, stormwater monitoring, and water quality monitoring. Local, state, and federal guidance and regulations are operable to be integrated with this data to provide insights for compliance with guidance and regulations dynamically and in real-time for a specific geographic location, as determined by location data provided by user devices or location sensing hardware.

Referring now to the drawings in general, the illustrations are for the purpose of describing one or more preferred embodiments of the invention and are not intended to limit the invention thereto.

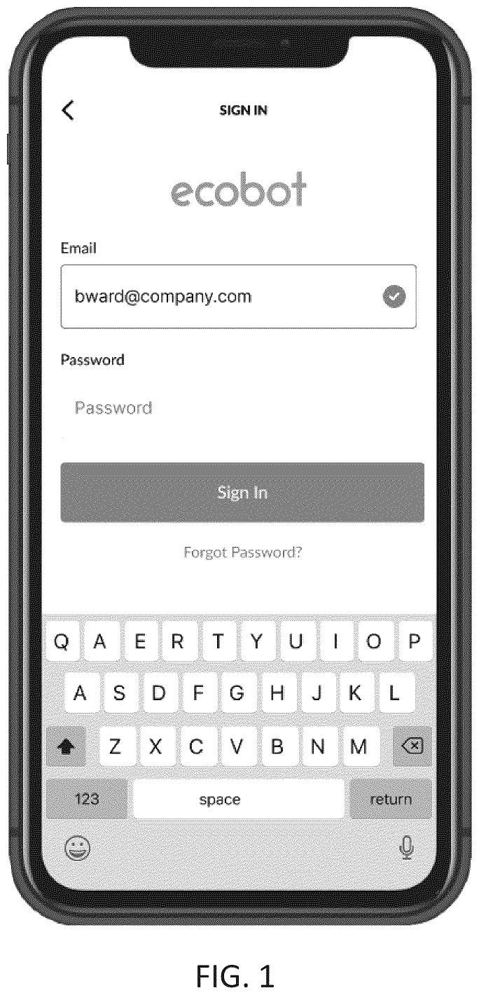

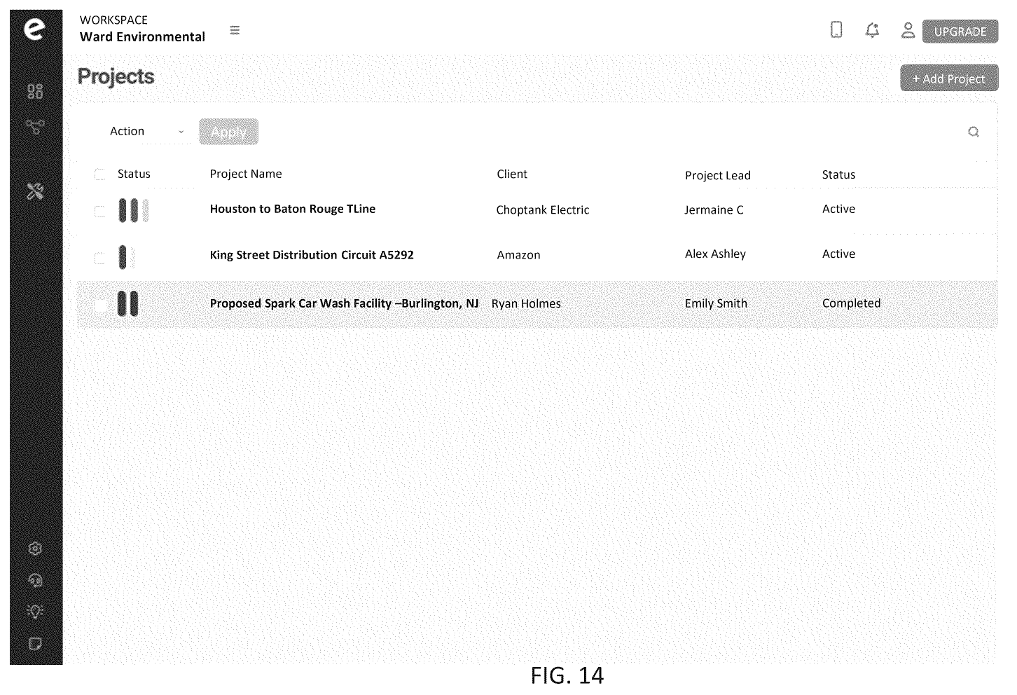

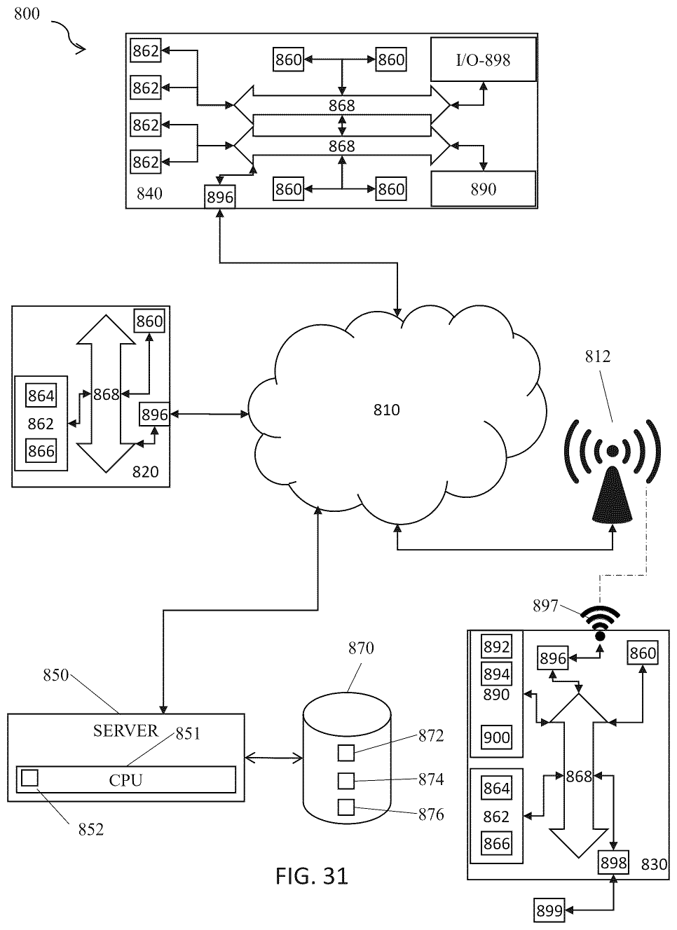

FIGS. 1-13 illustrate the data collection functionality of the platform according to one embodiment of the present invention. FIGS. 14-30 illustrate data management functionality of the platform according to one embodiment of the present invention. The data collection and data management platform is operable to be implemented by a desktop user device or a mobile user device such as a phone or tablet, or on combinations thereof. FIG. 31 is a schematic diagram which provides detail on how the system communicates with a plurality of devices in real time, and the storage functionality of the devices and platforms disclosed herein.

The data collection and data management platform of the present invention is configured to provide information relevant to environmental evaluation and consulting, and more specifically provides several features or outputs including accounts for accessing the platform, data, reports, projects, and different file formats for importing or exporting data. Prior art platforms may include data collection and management, but the system of the present invention incorporates administrative capabilities such as accessibility locks to prevent data overwriting and control security, as well as extensive data libraries for researching data points (e.g., species of vegetation). This is a significant advantage over platforms of the prior art, which are limited in functionality, contain no overwrite prevention features, do not allow for real-time vegetation research, and do not include administrative management features or interfaces.

In one embodiment of the present invention, the user accounts associated with the platform of the present invention are automatically available on the data management platform. In one embodiment of the present invention, the platform includes one or more administrative accounts. An administrative account according to the present invention is operable to add, remove, edit, and assign user accounts associated with the platform of the present invention.

FIG. 1 illustrates a sign-in portal of the data collection functionality of the platform according to one embodiment inf the present invention. The sign-in portal displays an email prompt and password prompt for a user account associated with the platform of the present invention. The sign-in portal includes an option to create a new password if the password associated with the user account has been forgotten. Upon input of the password and email associated with the user account, the platform of the present invention allows a user to access the account associated with the email address.

In one embodiment, the platform displays a sign-in portal upon opening of the platform on a user device. In one embodiment, the platform of the present invention receives a touchscreen, click-select, or typed input to open the sign-in portal. In one embodiment, the platform of the present invention saves the email and/or password of a user account and auto populates the email prompt and/or the password prompt with the saved email and/or password. In one embodiment, the platform includes a phone number associated with an account. In one embodiment, the platform prompts for the phone number associated with an account. In one embodiment of the present invention, the platform includes one or more contact methods associated with a user account.

One of ordinary skill in the art will appreciate the inherent functionality necessary to create a new password for a sign-in option, including but not limited to receiving an input response to one or more security questions and verifying the answer matches a predetermined response, verifying one or more codes using two-factor authentication, and/or accessing an email associated with the account. Each of these functionalities is operable to be utilized to create a new password or provide for account access individually or in combination according to the present invention.

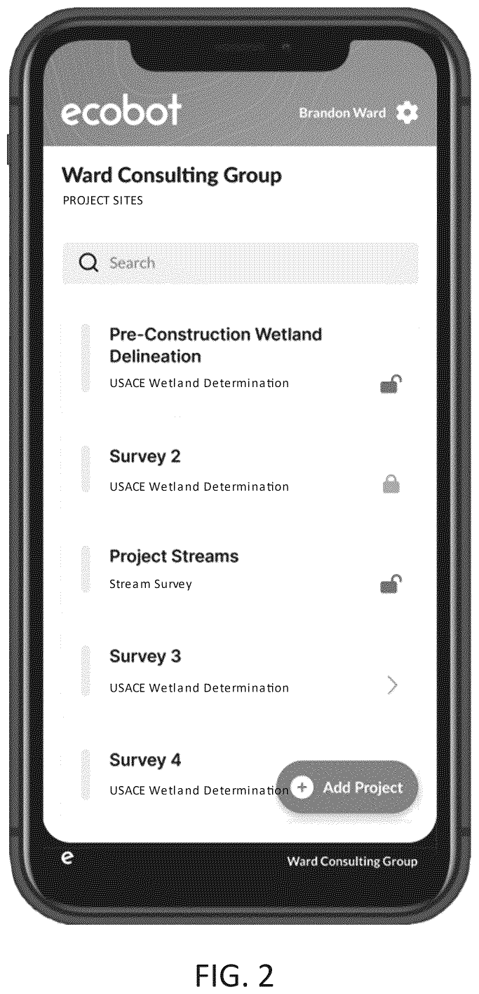

FIG. 2 illustrates a dashboard of a user account according to one embodiment of the present invention. The dashboard includes the name of the company, organization, or industry associated with the email address of the user account. The dashboard includes a list of the projects, project types and project sites associated with a user account, as well as an indication of the accessibility status of the project. The dashboard includes a search bar configured to receive a touch-screen, click-select, or typed input of a project name, project type, region, internal project ID, name of an investigator associated with the account, name of the applicant and/or owner of the project, city, county, section, township, range, subregion, and/or any other identifying information associated with a project associated with the user account and/or the company, organization, or industry associated with the user account.

In one embodiment, the email address associated with the user account is linked to multiple companies, organizations, and/or industries. In one embodiment upon opening the dashboard, the platform of the present invention receives a selection of the company, organization, or industry associated with a desired project. In one embodiment upon opening the dashboard, the platform of the present invention displays the dashboard of the most recently used company, organization, or industry associated with the user account. In one embodiment, the present invention includes a drop-down menu, typed response, or other method of selection an option from multiple choices on a GUI known to one of ordinary skill in the art. In one embodiment, the platform of the present invention prevents the same email address from being used to create an account associated with more than one company, organization, or industry. One of ordinary skill in the art will understand the necessary redundancy prevention functionality for disallowing a single email address for use in the creation of more than one user account.

The accessibility status indicator for each project displays the availability of the data related to the project. In one embodiment, the accessibility status indicator is a standard lock icon displaying an open lock for projects which have been checked out by the user account. In one embodiment, the accessibility status indicator is a standard lock icon displaying a closed lock for projects which have been locked by another user account. In one embodiment, a project which has no accessibility status indicator is available for checkout by a user account. This prevents the overwriting of data that is common in the data platforms of the prior art. When collecting data for a project according to prior art systems, there is no locking mechanism to prevent other users from overwriting the data on a project that is in progress, causing deletions and repetitions of integral data. Likewise, this prevents duplicative reporting for projects by indicating that another user account is working on the project. Projects that are not locked indicate that there is no other user account currently working on that project and thus a user account is operable to access the project without worrying about duplicating work done by another user account or overwriting data as it is being collected.

The dashboard includes a selectable add project feature. In one embodiment, the platform receives an input via known input methods (touchscreen, type, click-select, etc.) selecting the add project feature. Upon receiving a selection of the add project feature, the platform of the present invention generates a project addition page.

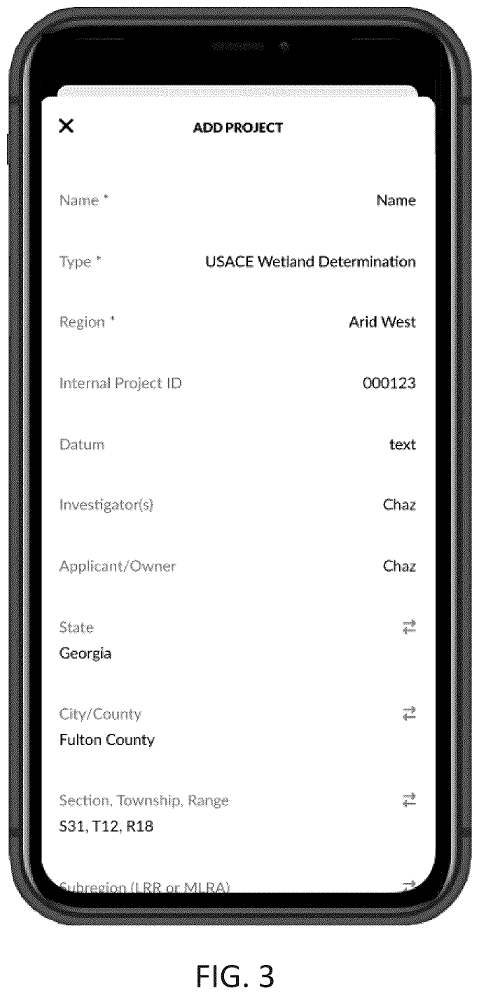

FIG. 3 illustrates a project addition page according to one embodiment of the present invention. The project addition page includes one or more prompts for typed, touchscreen, and/or quick select input, including but not limited to project name, project type, region, internal project ID, name of an investigator associated with the account, name of the applicant and/or owner of the project, city, county, section, township, range, subregion, and text data associated with the project.

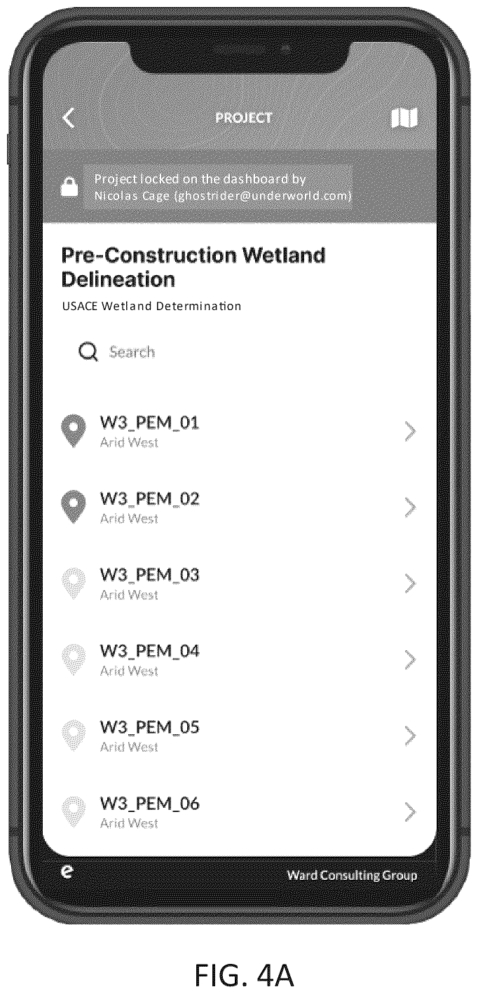

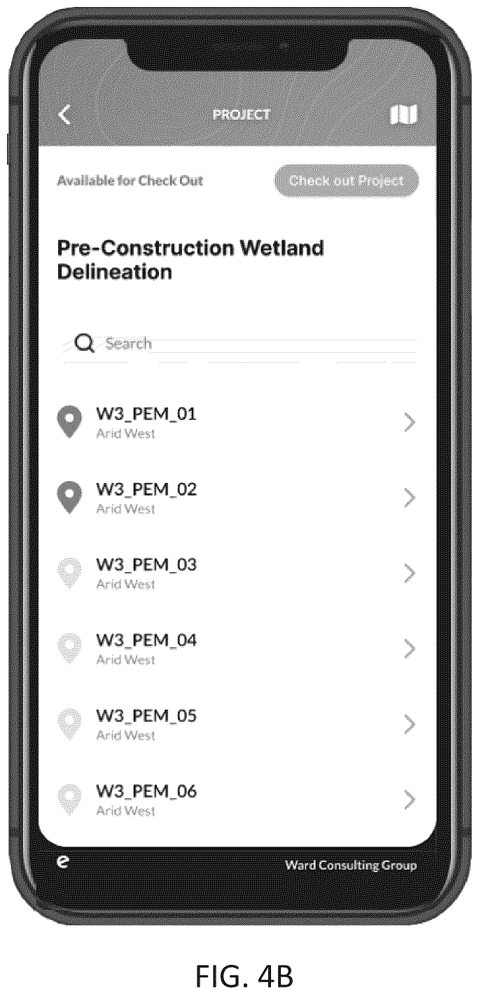

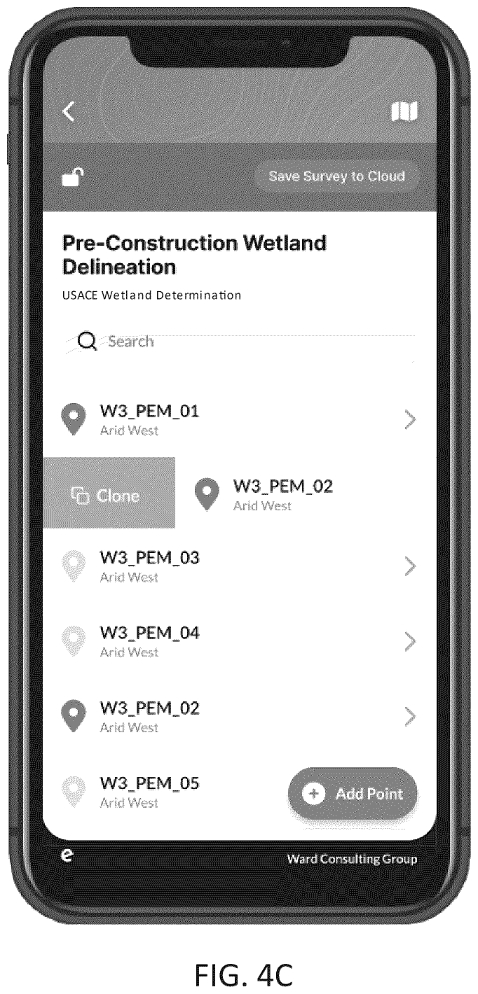

FIGS. 4A-4C depict a project home page according to one embodiment of the present invention. FIG. 4A depicts the project home page of a project that is locked for editing by another user account. FIG. 4B depicts the project home page of a project that is available for check out by a user account. FIG. 4C depicts the project home page of a project that is checked out by a user account. The project home page includes an accessibility status banner, and a list of data appoints included in the project. The project home page includes a search bar for locating specific points included in the project, including but not limited to data recorded at each point. In one embodiment, an authorized individual account is operable to lock a project to prevent a user account from accessing the project via a mobile device or a desktop computer to ensure data integrity, safety and security when a mobile user is collecting data in the field without internet connection.

The project home page includes a selectable add point feature. In one embodiment, the platform receives an input via known input methods (touchscreen, type, click-select, etc.) selecting the add point feature. Upon receiving a selection of the add point feature, the platform of the present invention generates a point addition page.

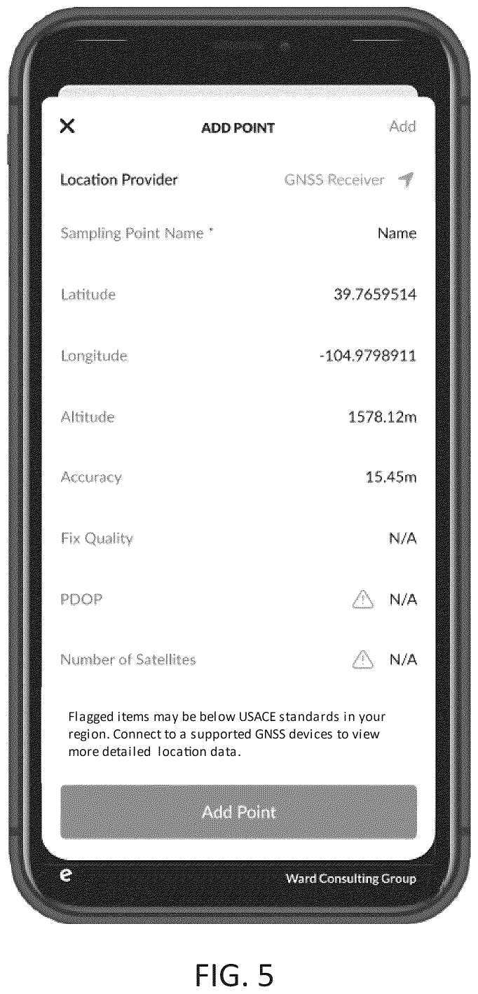

FIG. 5 illustrates a point addition page according to one embodiment of the present invention. The point addition page includes one or more prompts for typed, touchscreen, automatic detection, and/or quick select input, including but not limited to location, location services provider, sampling point name, latitude, longitude, altitude, and when connected to external GNSS hardware via BLUETOOTH, accuracy, fix quality, position dilution of precision (PDOP), and/or the number of satellites associated with a data point (e.g., the number of satellites used to determine the location of the data point).

In one embodiment, the data points of the present invention are recorded by location, wherein the location of the data point is recorded and information regarding the environmental conditions of the specific data point is included within the point. In one embodiment, the location of a data point is a recorded GPS, GNSS, satellite, geolocation, or other location identified by locating technology. In one embodiment, the location of the point is classified according to a predetermined plot, grid, or other geographical mapping layout. For example, the environment associated with a project is divided into one or more plots based on a grid system, and the user account inputs the specific grid location wherein data is collected for that specific point. In one embodiment, the points are not recorded based on the location of the data collection.

In one embodiment, the platform of the present invention is configured to determine a datapoint that is not compliant with the United States Army Corp of Engineers (USACE) standards for data collection and reporting. In one embodiment, the platform of the present invention generates an alert to the user device associated with a user account upon detecting a data point that is not compliant with USACE standards. In one embodiment, this notification includes a button, wherein selecting the button via touchscreen or click select automatically opens the project point associated with the defective data. In one embodiment, the platform of the present invention generates an alert to the user device associated with a manager account upon detecting a data point that is not compliant with USACE standards.

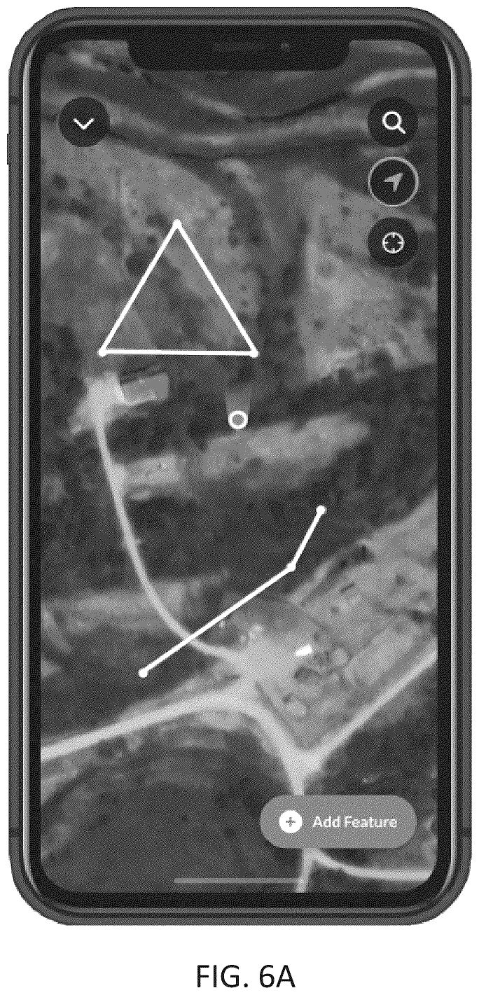

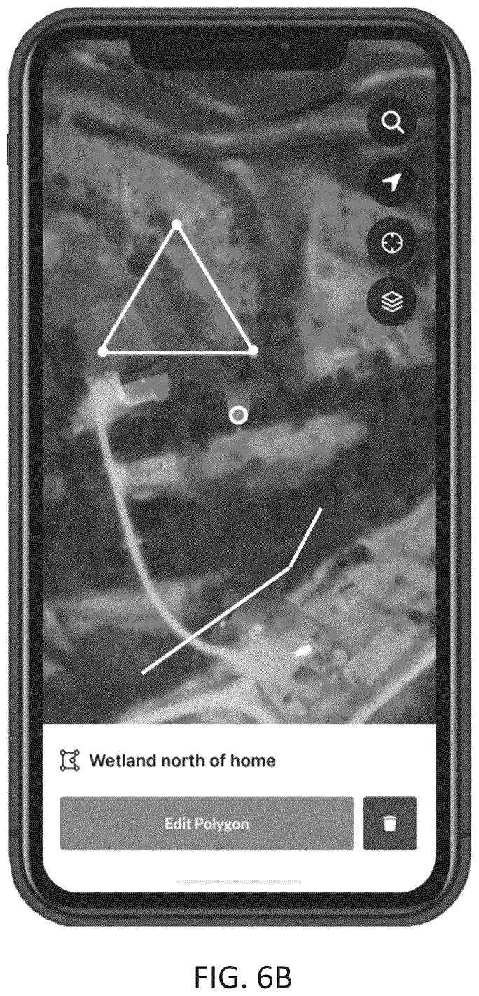

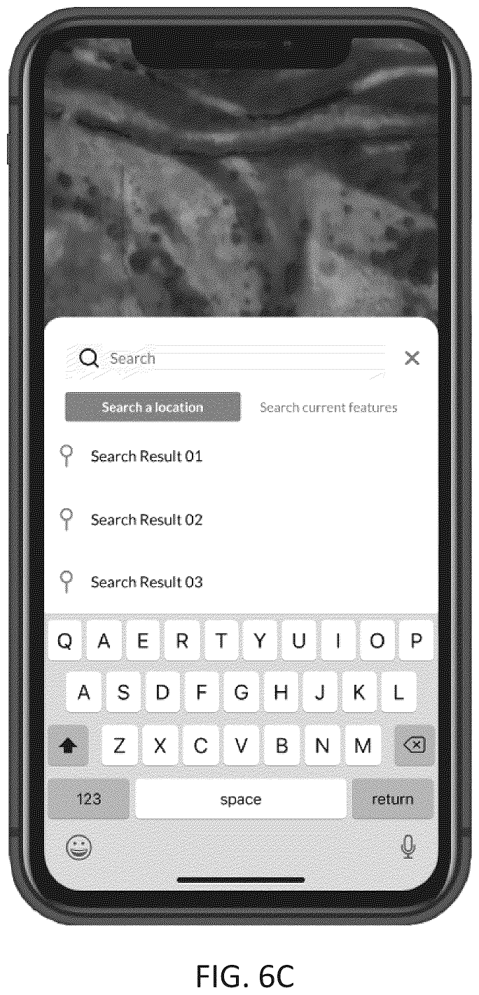

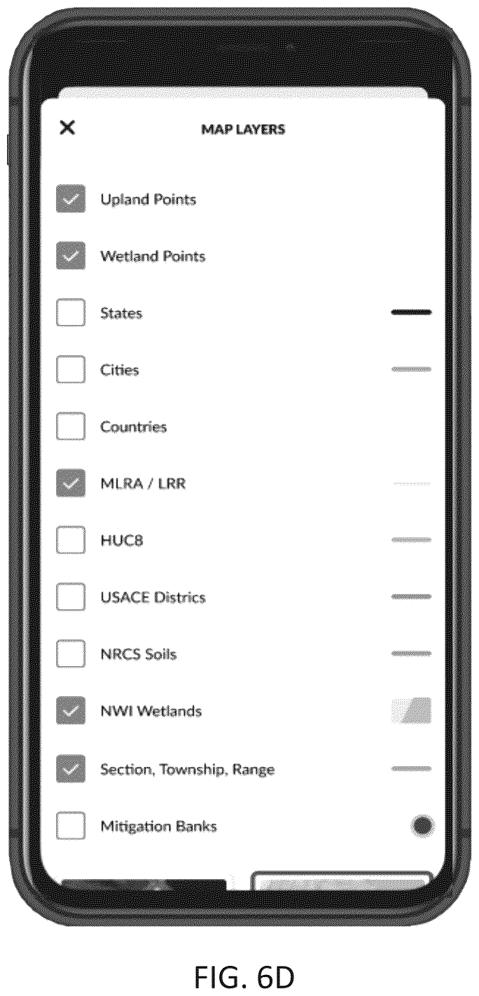

FIGS. 6A-6D illustrate a geographical map associated with a project according to one embodiment of the present invention. FIG. 6A illustrates the location of multiple data points collected for a project. The geographical map display includes a search bar, a live location tool, a locating tool, and a layer tool, as well as an add feature select option. FIG. 6B depicts the locating feature wherein upon selection of the locating feature, the map recenters on the location of the user device. FIG. 6B further depicts the option to edit and/or delete the polygon created by connecting data collection points. FIG. 6C depicts the search bar display associated with the geographical map, wherein a user account is operable to input a location and/or features associated with a desired location to find the location. Upon selecting a location from the search bar, the location is then displayed on the geographical map of the present invention. FIG. 6D depicts the map layer tool of the present invention.

In one embodiment, the map layer tool includes one or more identifying colors, patterns, or indicators to indicate upland points, wetland points, states, cities, countries, major land resource areas (MLRA), land resource regions (LRR), hydraulic unit codes (e.g., HUC 8), USACE districts, Natural Resource Conservative Service (NRCS) Soils, National Wetlands Inventory (NWI) wetlands, section, township, range, and/or mitigation banks. In one embodiment, the user account selects a satellite view of the geographical map or a street view of the geographical map.

In one embodiment, upon selecting the add feature option of the geographical map display, a user account is operable to add either a polygonal feature or a line feature. The polygonal feature of the present invention includes data points at the apex of the polygonal shapes, wherein data is collected at the point indicated by each apex of the polygon. In one embodiment, the line feature includes data points at either end of the line, wherein a user account inputs a line on the geographic map to connect two data points where data has been collected. In one embodiment, the polygon and/or line is added before data is collected, wherein the polygon and/or the line is used to generate a location for data collection. In one embodiment, upon creation of the line or polygon, one or more data points are generated at the distal ends of the line and/or the apex points of the polygon.

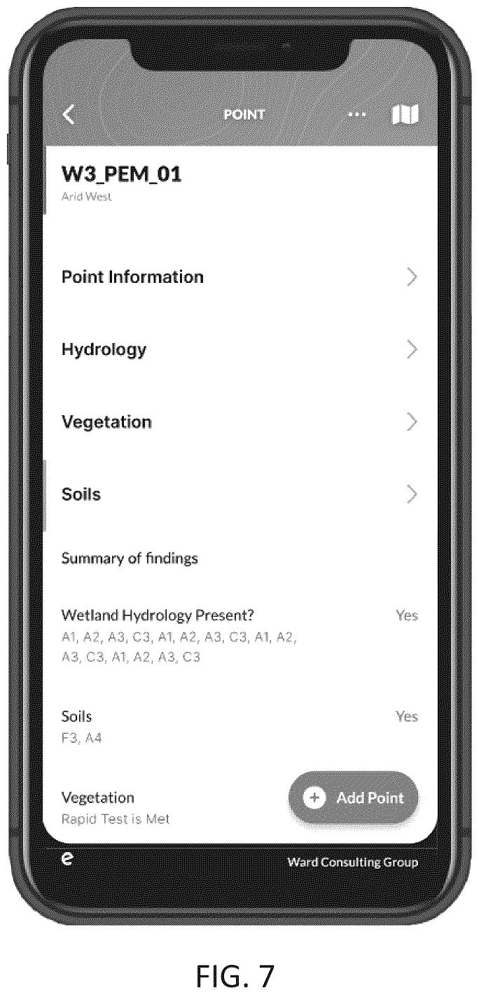

FIG. 7 illustrates a point home page according to one embodiment of the present invention. The point home page includes portals to multiple data categories associated with the selected point, including but not limited to point information, hydrology, vegetation, and soils, as well as a summary of the findings of each data category.

In one embodiment of the present invention, each data category includes a remarks section for recording additional remarks not related to the predetermined data variables. The remarks section of the present invention is not limited to typed input. In one embodiment, the remarks section allows for the upload of a text file, image file, audio file, PDF, SVG, DOC, DOCX, HTML, XLS, MOV, MP4, PPT, M4A, MP3, WAV, or any other file type known to one of ordinary skill in the art. In one embodiment, each data category is configured to receive a text file, image file, audio file, PDF, SVG, DOC, DOCX, HTML, XLS, MOV, MP4, PPT, M4A, MP3, WAV, or any other file type known to one of ordinary skill in the art.

In one embodiment, the data categories of the present invention include predetermined variables for data collection. For example, when evaluating the Arid West climate, a wetland determination or wetland delineation report must include an indication of the presence or absence of wetland vegetation. The platform of the present invention generates a sliding indicator to collect the data as to whether wetland vegetation is present or not. In one embodiment, the system of the present invention includes an indication that data input is required for one or more variables before the report is submitted. This is advantageous over the traditional method of gathering data on physical, paper reports, as there is no way to prevent a user from neglecting to fill out a certain data point associated with the report.

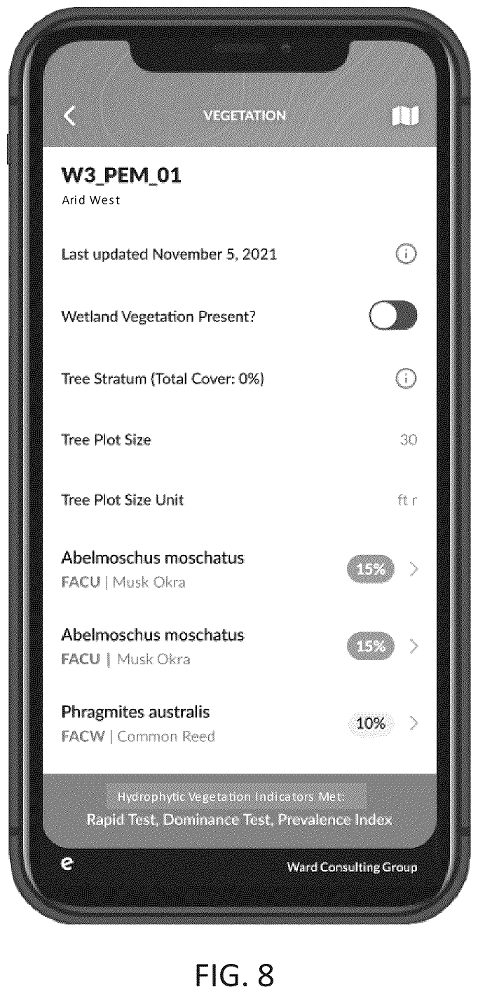

FIG. 8 illustrates the vegetation data category according to one embodiment of the present invention. The category of data includes touch screen selection, sliders, typed input responses, for multiple predetermined variables relating to the vegetation of the data collection point. The data category includes information icons associated with variables, wherein hovering over the information icon generates the USACE standard definition or other standard definition associated with the predetermined variable. The data category further includes an indicator banner, wherein the platform automatically generates a display of the necessary indicators that must be met for the report (e.g., Rapid Test).

In one embodiment, the vegetation data category includes a searchable list of vegetation by scientific name, species, or other classification. In one embodiment, the list of vegetation available for selection using the platform of the present invention is kept up to date to ensure accuracy. This is advantageous over physical reporting, as the physical identification of vegetation depends on a user's ability to identify the vegetation and either remember the species or identify the vegetation using a photograph field manual. These field manuals are heavy, presenting a significant physical burden to the user, and require physical updating upon discovery of new species. This takes time and creates the possibility that newly discovered vegetation will not be identified because there is a delay between the discovery of new species and the addition of photographs if these new species to the photographic field manual.

The present invention includes multiple data libraries for normalization of collected data. Data is preferably normalized according to standardized, pre-formatted selection tools or data libraries defined by regulatory or government agencies. The present invention provides for compliance with these formats by automatically formatting data into these formats.

In one embodiment, the platform receives one or more photographs or images of vegetation and is operable to use AI-based visual analysis to provide one or more likely vegetative species corresponding to the one or more photographs. In one embodiment, the platform provides confidence levels for each of the one or more likely vegetative species. In one embodiment, the platform designates one of the one or more likely vegetative species as the primary species, while any other results as labeled as alternative possibilities. In one embodiment, the images are tagged with one or more category labels in order to enhance accuracy of the determination of the vegetative species. In one embodiment, the one or more category labels correspond to different parts of the vegetation (e.g., auto, leaf, bark, flower fruit, etc.). In one embodiment, the one or more category labels correspond to a type of vegetation (e.g., tree, bush, grass, etc.). In one embodiment, a wetland indicator status is provided unique to a location of the data collector. In one embodiment, the AI-based visual analysis utilizes API integration with one or more AI-based image analysis tools.

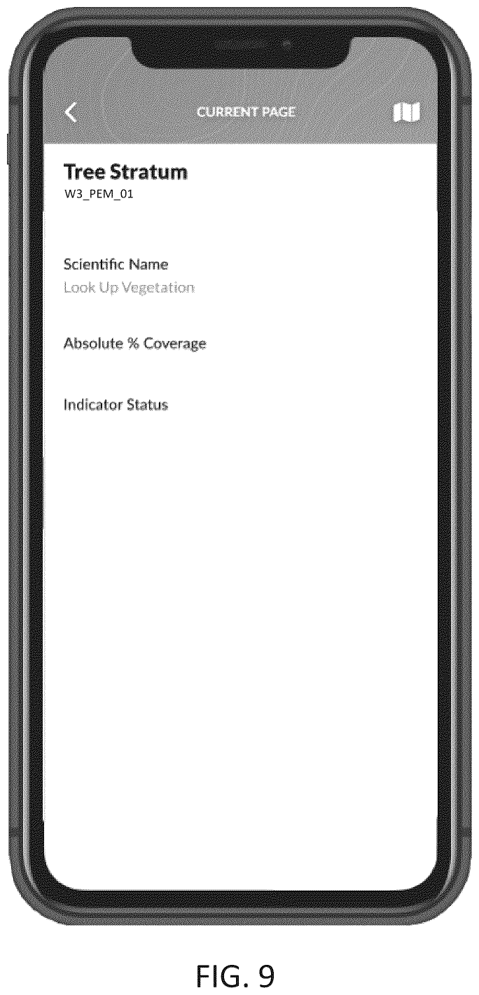

FIG. 9 illustrates a vegetation research page according to one embodiment of the present invention. The data variable for each vegetation includes a vegetation research page wherein a user account accesses and searches the searchable list of vegetation for the variable. The vegetation research page further includes a percentage of absolute coverage for each vegetation as well as an indicator status of each identified vegetation. Indicator status ratings for vegetation include but are not limited to obligate wetland (OBL), Facultative Wetland (FACW), Facultative (FAC), Facultative Upland (FACU), and Upland (UPL).

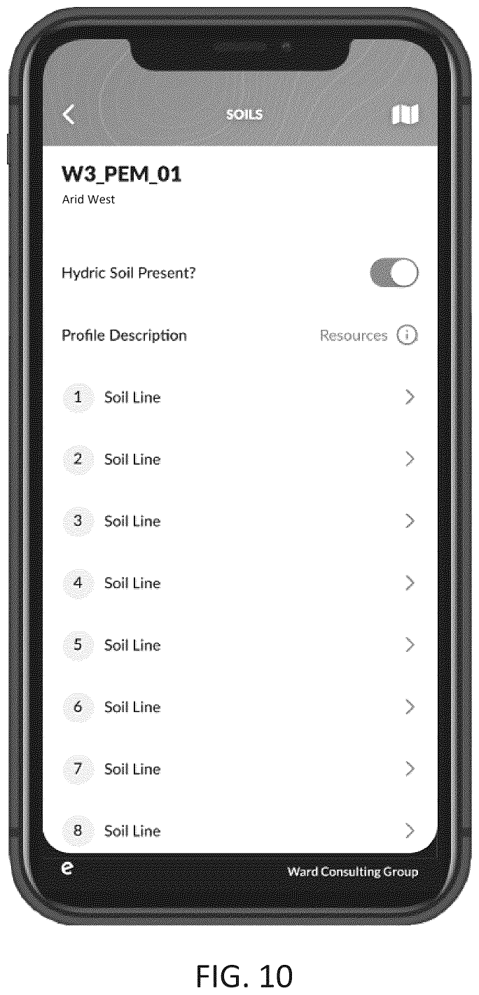

FIG. 10 illustrates a soil data category according to one embodiment of the present invention. The soil data category includes portals to each soil line identified at the data collection point. The soil data category page further includes a resource link to assist with identification of soil hue, value, and chroma. In one embodiment, the present invention generates a soil categorization visual upon receiving a selection of the resource link.

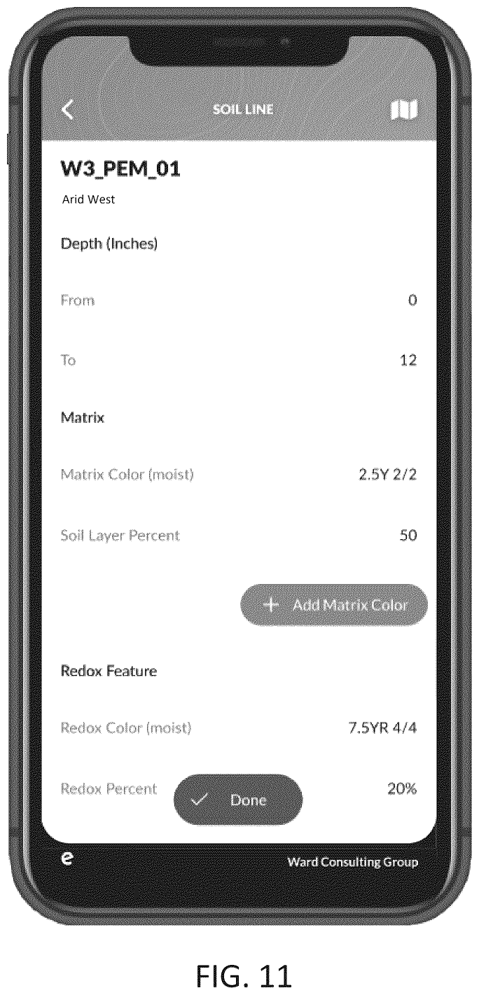

FIG. 11 illustrates a soil line page according to one embodiment of the present invention. The soil line page includes touch screen selection, sliders, typed input responses, for multiple predetermined variables relating to a soil line identified at the data collection point. The data collected for each soil line includes but is not limited to depth, matrix color, soil layer percent, redox color, redox percent, redox type, redox location (i.e., redox in the pore lining or redox in the matrix), texture.

In one embodiment, multiple soil lines are identified at a single data point. In one embodiment, the platform of the present invention separates each soil line while allowing a user account to manipulate the information relating to the soil as a whole and/or each soil line individually. In one embodiment, the platform includes an image of the soil stratum displaying the layers of each soil type, including an overlay of the depth of each layer. In one embodiment, the soil line page includes an image of the soil line taken from the data collection sight.

In one embodiment, the platform is operable to provide hydric soil indicator suggestions based on location, depth, color, texture, and/or other factors. In one embodiment, the platform provides back color coding to indicate likelihoods of various hydric soil indicators. The platform is further able to provide custom help and guidance inline to help determine accurate indicators while an operator is in the field in both mobile and web application versions.

While FIGS. 4A-11 illustrate data collection with regards to pre-construction wetland determination or wetland delineation, one of ordinary skill in the art will appreciate that there are multiple project types associated with environmental evaluation which the platform of the present invention is operable to capture (e.g., a Stream Survey).

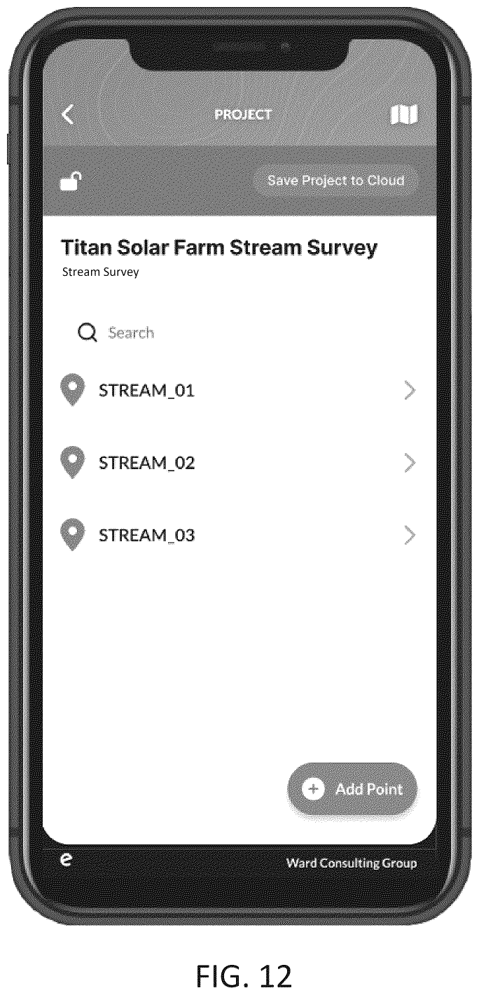

FIG. 12 illustrates a point home page of a stream survey according to one embodiment of the present invention. The stream survey includes the add point feature as disclosed herein for addition of data points. The stream survey further includes the search bar feature for identifying a specific data point as disclosed herein. The point home page for the stream survey includes a list of points for the stream survey. In one embodiment, stream water is collected and surveyed at each data point.

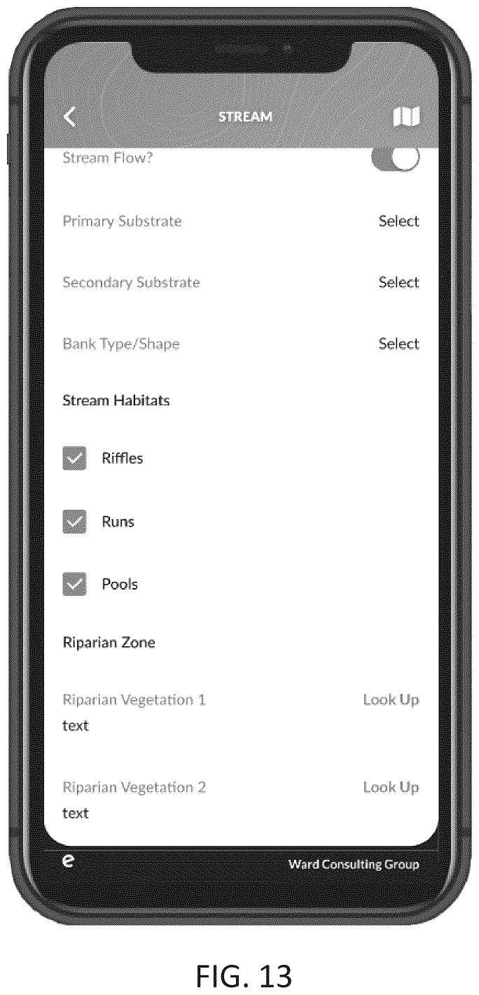

FIG. 13 illustrates a stream sampling data point page according to one embodiment of the present invention. The data recorded on the stream sampling data point page includes data variables relating to stream identification, information, morphology, habitats, and riparian zones. The data point page further includes a riparian vegetation research portal, wherein selecting the research portal generates a vegetation research page as disclosed herein, including riparian vegetation.

Data variables relating to the stream information include but are not limited to survey name, internal project ID, stream name, sampling date, investigator (e.g., the user account associated with an investigator), the applicant/owner, state where the sample was collected, city/county of the sample collection, section, township, range, latitude, longitude, images/video relating to the sample, and NWI classification. Data variables relating to the stream identification include but are not limited to National Hydrology Database (NHD) name of the stream (i.e., if it exists and/or what the name is), the Geographic Names Information System (GNIS) name of the stream, and classification. Data variables relating to the stream morphology include but are not limited to units, bank height (i.e., right and left bank height), water depth, width of the stream at the ordinary high water mark (OHWM) and the top of bank (TOB), stream flow, primary substrate, secondary substrate, and bank type/shape. Data variables relating to the stream habitat include but are not limited to the presence and/or location of riffles, runs, and/or pools. Data variables relating to the riparian zone include but are not limited to one or more riparian vegetation species. The platform of the present invention provides for stream identification, or stream delineation, based on data collected from mobile devices.

The data collection functionality of the platform of the present invention allows user accounts to upload data from mobile devices located at the physical data point. The data is uploaded to the database of the present invention. This allows the platform of the present invention to access the data in real time upon the upload of the data by the user device implementing the platform.

FIG. 14 illustrates a project dashboard showing the data management functionality of the platform according to one embodiment of the present invention. The dashboard includes a list of projects associated with a company, organization, and/or industry. Each project includes an activity status bar indicator showing the progress of each project and/or the subcomponents of the project, as well as a status label showing the activity relating to the report. The dashboard further includes a search bar configured to receive a touch-screen, click-select, or typed input of a project name, project type, region, internal project ID, name of an investigator associated with the account, name of the applicant and/or owner of the project, city, county, section, township, range, subregion, and/or any other identifying information of a project associated with an administrative account and/or the company, organization, or industry associated with the administrative account. The search bar is further configured to receive an input of an email or username for identifying a client account or a user account. The dashboard further includes an option to select one or more projects and includes a dropdown action menu to transfer or archive selected projects upon receiving an input to do so via touchscreen and/or click select. The dashboard includes an add project feature for creating additional projects.

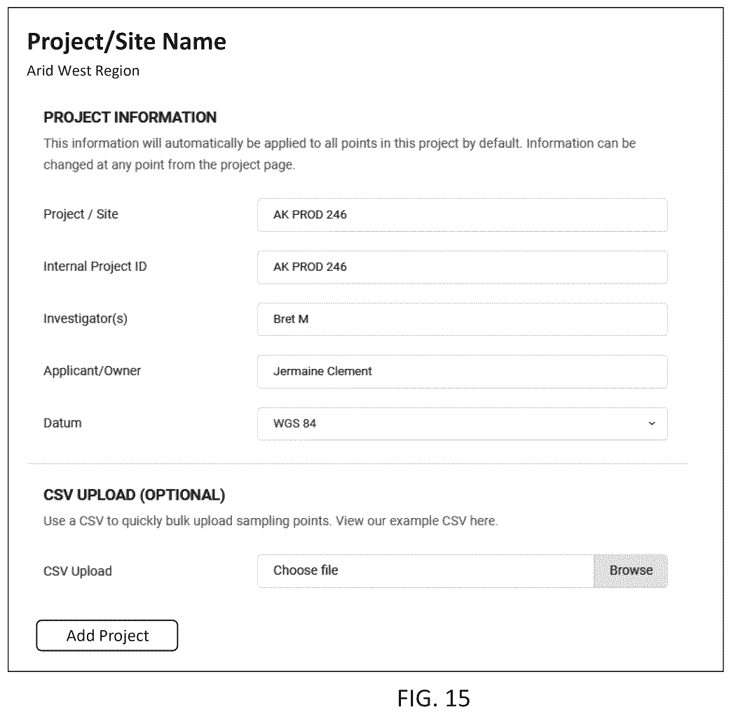

FIG. 15 illustrates a project addition page of the data management functionality of the platform of the present invention. The project addition page includes prompts for data relating to the new project. In one embodiment, the project addition page is used to add a site to an existing survey and/or project.

In one embodiment, the project addition page of the platform on a mobile device is similar in features and functionality to the project addition page displayed on a desktop computer. In one embodiment, data inputs and GUIs are different for mobile devices and desktop computers. Data is operable to be synced to the cloud, one or more servers, and/or with one or more edge devices. In one embodiment, data is collected by a user device in a field, and analysis is operable to be performed on an edge device in proximity to the user device. Data files are operable to be sent as JSON text files or binary data (for images, such as photographs). An application programming interface (API) is operable to process the data and store it in a database or send it to another device for review or analysis. In one embodiment, the project addition page includes prompts for the project/site identifier, internal project ID, investigator (i.e., user associated with a user account), applicant/owner (i.e., a client associated with a client account), and a datum associated with a geographical locating schema (e.g., the World Geodetic System 1984 [WGS84]). The project addition page further includes a CSV file upload option for including tables and other structured data formats to the newly created project. In one embodiment of the present invention, the platform uses WGS84 for regulating data. In one embodiment, the platform uses the North American Datum 1983 (NAD83) for regulating data.

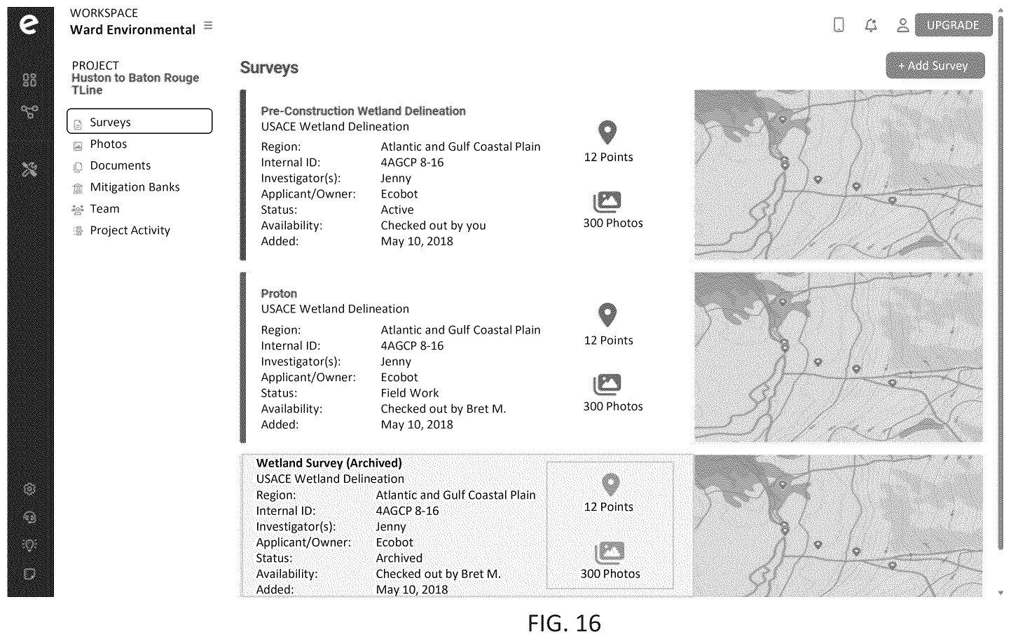

FIG. 16 illustrates a project page of the platform according to one embodiment of the present invention. The project page includes a quick access menu including a portal to the surveys collected for the project, a portal to the media gallery, a portal to the documents page, a portal to the mitigation banks page, a portal to the team page listing user accounts, administrator accounts, and super administrator accounts, and a portal to the project activity page. The project page further includes a list of the surveys associated with the selected project, including but not limited to pre-construction wetland delineation surveys, proton surveys, wetland surveys, and stream surveys.

Other types of projects include, by way of example and not limitation, projects relating to natural resources, vegetation analysis, soil analysis, groundwater monitoring, environmental remediation, mitigation banking, mammalian species, aquatic species, organic material analysis, biodiversity credits, carbon footprint, forest surveys, threatened and endangered species, stormwater monitoring, and water quality monitoring. The location of each survey point within the survey is displayed on the geographical map preview shown alongside each survey, including an indication of the number of photos taken and/or the number of media uploads performed with respect to the survey point, and the number of data collection points used in the survey.

In one embodiment, the surveys for a project are color coded according to activity status. In one embodiment, surveys are listed including an activity status bar indicator corresponding to the status bar indicator of the dashboard, wherein the status bar indicator displays the progress of each survey included within a project. For example, the displayed example project includes three activity status indicator bars, one green bar, one dark gray bar, and one light gray bar. In one embodiment, the activity status indicator bar is colored green to indicate a user account actively working on the report (e.g., gathering data or formatting inputs). In one embodiment, the activity status indicator bar is colored dark gray to indicate a completed survey. In one embodiment, the activity status indicator bar is colored light gray to indicate a survey that has not yet been completed.

In one embodiment, the surveys of the project are color coded according to project status. For example, the example project includes three project status indicator bars, one green bar, one dark gray bar, and one light gray bar. In one embodiment, the project status indicator bar is colored green to indicate a survey that has been checked out by the administrator account. In one embodiment, the project status indicator bar is colored dark gray to indicate a survey that is in progress. In one embodiment, the accessibility status indicator bar is colored light gray to indicate a survey that has not yet been started.

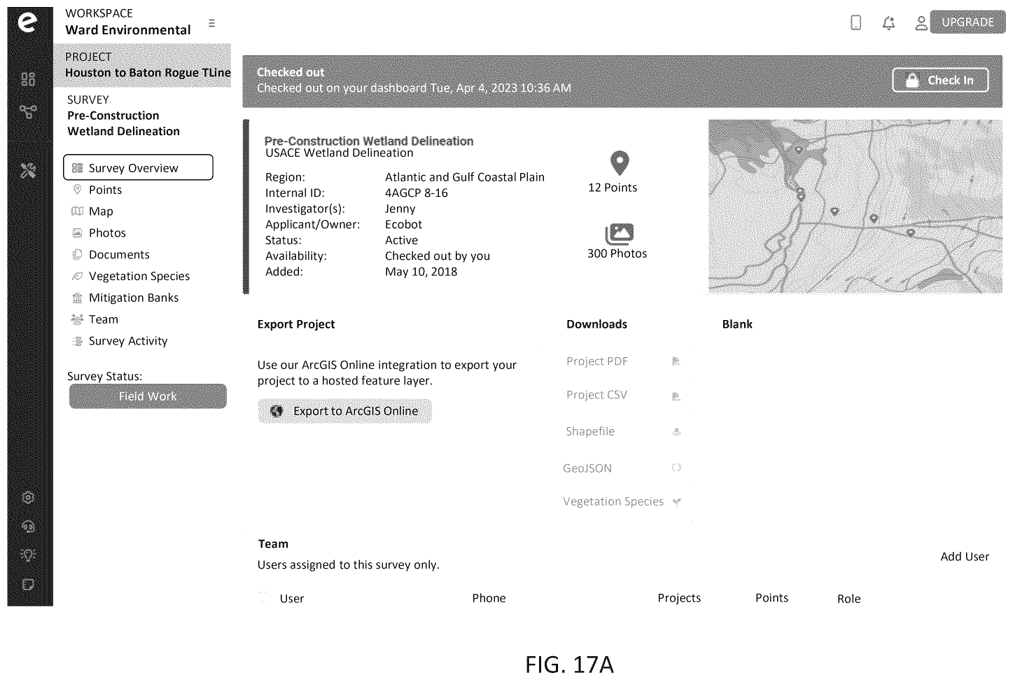

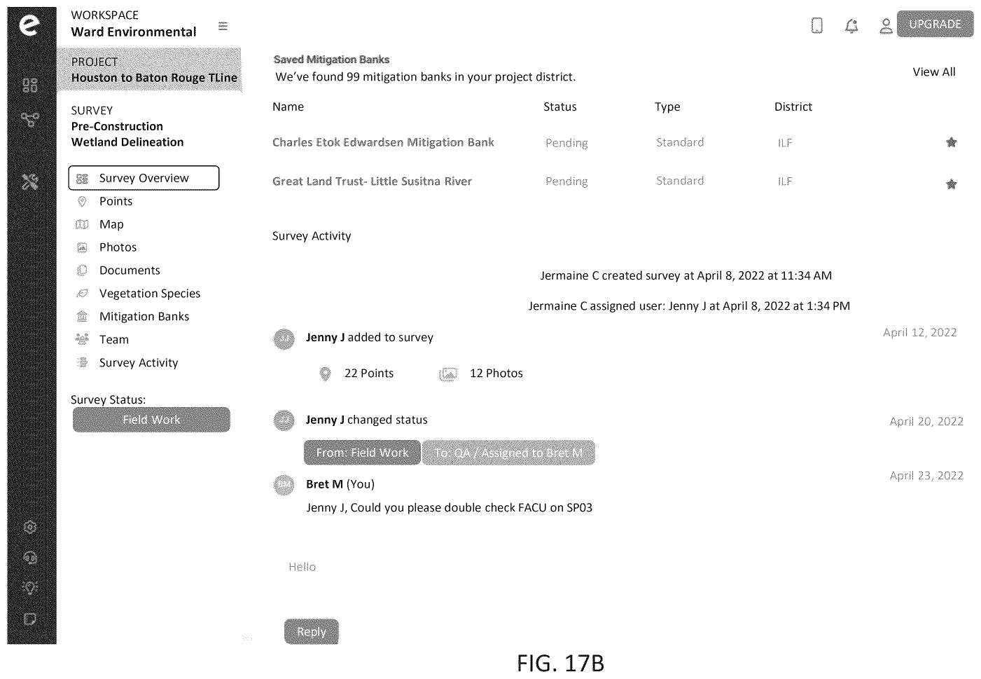

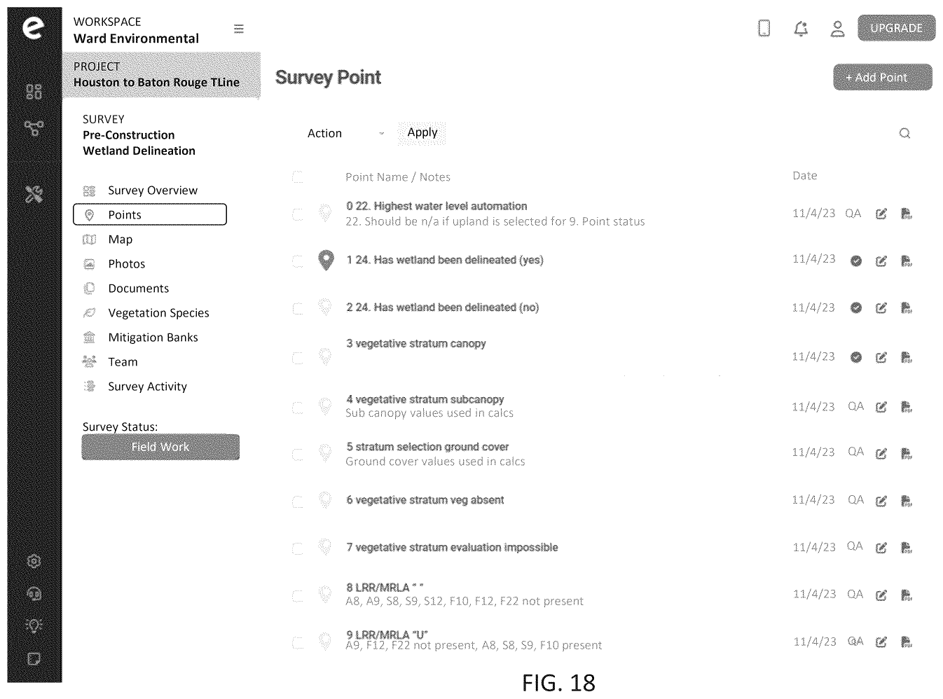

FIGS. 17A-17B illustrate a survey overview page according to one embodiment of the present invention. The survey overview page includes a quick access menu including a portal to the points collected for the project, a portal to the map of the surveyed geographical area, a portal to the media gallery, a portal to the documents page, a portal to the vegetation species page, a portal to the mitigation banks page, a portal to the team page listing user accounts, administrator accounts, and super administrator accounts, and a portal to the survey activity page. The survey overview page further includes a survey status feature, wherein selecting the survey status feature generates a set survey status page. The export project feature of the survey overview page enables a user account and/or other account to export the survey and/or project to a client-server online geographic information system (e.g., ARCGIS ONLINE).

In one embodiment, the platform of the present invention is integrated with a client-server online geographic information system. In one embodiment, the data collection platform of the present invention is integrated with a client-server online geographic information system. In one embodiment, the integration of the platform with the client-server online geographic information system automatically enables the integration of the data collection platform with the client-server online geographic information system and vice versa. In one embodiment, the client-server online geographic information system is ARCGIS ONLINE.

In one embodiment, the platform of the present invention is operable to download a. PDF, .CSV,.SHP,.SHX,.DBF, GeoJSON, Geodatabase, or other GIS file format from the survey overview page of the present invention. In one embodiment, the platform of the present invention is operable to export a .PDF,.CSV,.SHP,.SHX,.DBF, GeoJSON, Geodatabase, or other GIS file format from the survey overview page of the present invention. In one embodiment, a text file, image file, .PDF,.SVG,.DOC, DOCX,.HTML,.XLS, or any other file type known to one of ordinary skill in the art uploaded using the data collection platform of the present invention is automatically available for download via the interface of the platform or via access controls. By providing for files to be exported in a variety of different formats, the present invention provides for analysis and presentation of the collected and analyzed data via a variety of other programs.

FIG. 17A illustrates the accessibility status of projects according to one embodiment of the present invention. The accessibility of the platform reflects the accessibility functionality of the data collection platform. In one embodiment, a survey and/or project is only accessible for editing and/or viewing if the survey and/or project has been checked out by the user account or administrator account attempting to access the survey and/or project. This prevents fieldworkers and office workers from unintentionally overwriting each others' data, or contributing conflicting changes while a fieldworker is offline and not connected to the internet. To check out a survey and/or project, a user account or administrator account selects a Check Out feature displayed on the survey overview page of the present invention. To check in a survey and/or project that has been checked out, the user account or administrator account associated with the checked out survey selects the Check In feature displayed on the survey overview page. In one embodiment, the Check In feature is only displayed to the survey overview page of the user account or administrator account associated that has checked out the survey and/or project. In one embodiment, the Check Out feature is displayed to the survey overview page of any user account or administrator account associated with a survey and/or project that has been checked out by that user account or administrator account.

Additional data security control and overwrite prevention measures are provided in accordance with the present invention. TLS encryption, such as TLS 1.3 encryption, is operable to be utilized for secure transmission of data. The data of the present invention is not modifiable via third party applications but is only operable to be modified via a user with proper permissions according to the platform of the present invention. The platform also includes data logs which catalog activity in the platform, including account creation, modification, or deletion, assignments of permissions or privileges, authentication requests including the status of each request (e.g., success or failure), usage information including transaction types, transaction sizes, and transaction volume, administration logons and logoffs, configuration changes by administrators and non-administrators, changes to logging and audit functionality, and deletion of audit logs.

As displayed in FIG. 17B, the survey overview page includes a display of the saved mitigation banks located within an identified geographic area (e.g., a district) provided via an API connection to the USACE Regulatory In-lieu Fee and Banking Information System (RIBITS) system. This abbreviated mitigation bank display includes the name of the mitigation bank, the status of the transaction and/or determination of the area associated with the mitigation bank as suitable for use in mitigation banking, the type of mitigation bank, and the district in which the mitigation bank is located. In one embodiment, the present invention includes an option to save, favorite, and/or otherwise mark as important one or more mitigation banks associated with a geographical area. The survey overview page further includes an abbreviated display of the relevant account activity associated with the survey and/or project.

FIG. 18 illustrates a points page of the platform according to one embodiment of the present invention. The points page includes a list enumerating the name of each data point collected for a survey as well as notes collected with respect to that data point. Each listed data point includes the date of collection of the data point, recorded simultaneously with the data collected via the data collection platform of the present invention. Additionally, each point includes an option to view the questions and answers associated with the survey point, download the questions and answers associated with the point, or edit the data associated with the point. The points page further includes a dropdown menu including one or more actions for application to one or more points, as well as a search for locating one or more survey points by typed, touchscreen, or click select of data included within the point (e.g., email associated with the user account used to collect the data included in the survey point).

In one embodiment of the present invention, the points page of the platform includes an add point feature. In one embodiment, upon selection of the add point feature, the platform generates a points editing page according to one embodiment of the present invention.

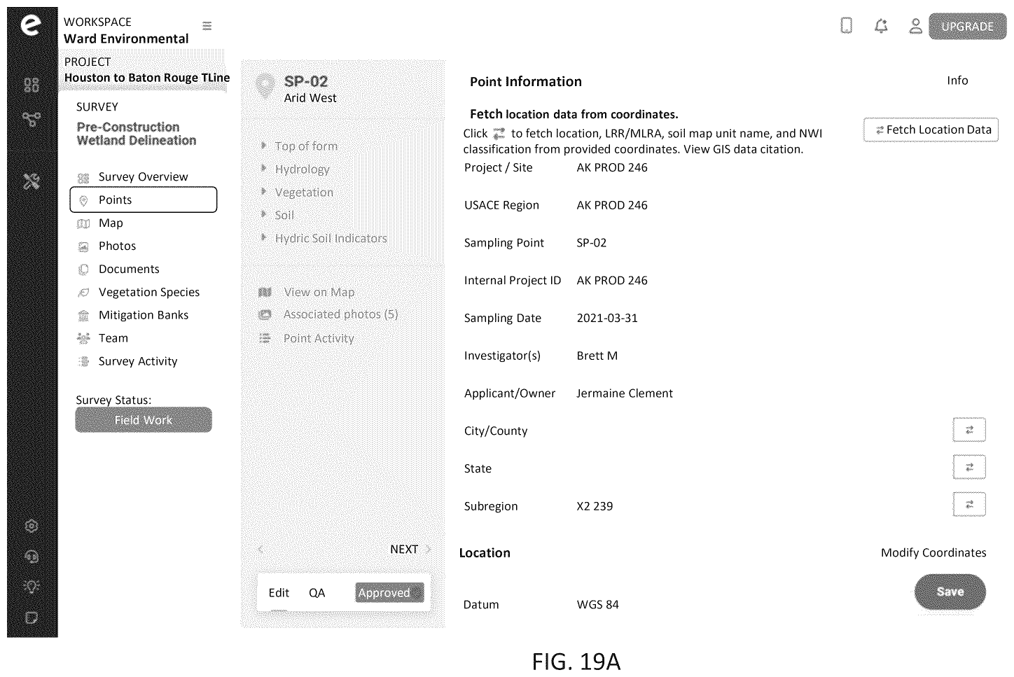

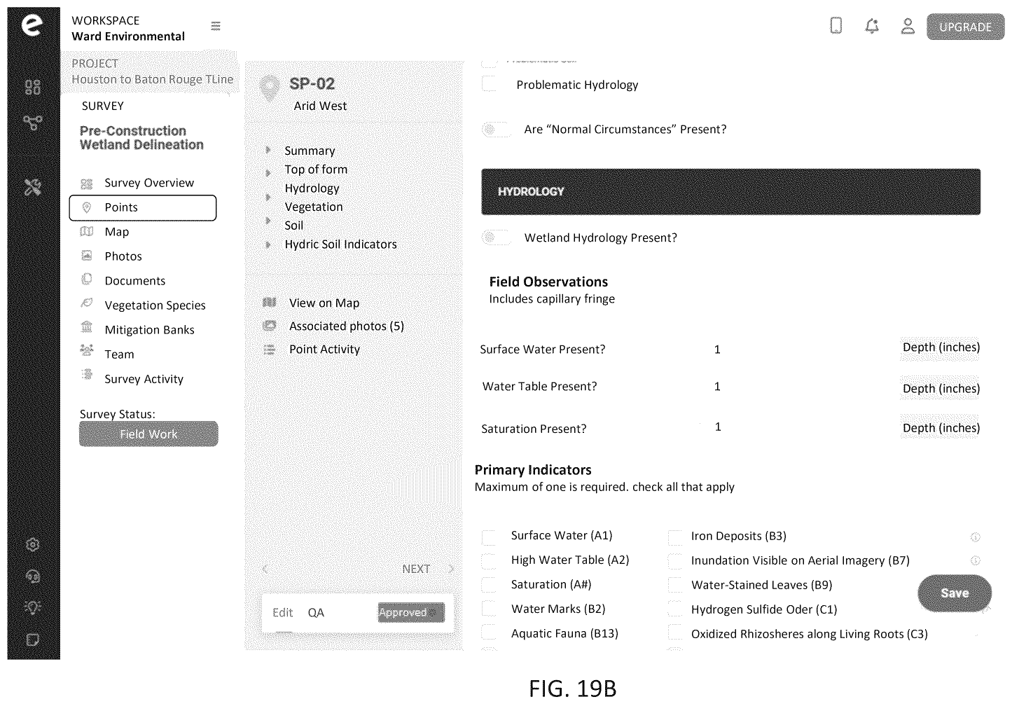

FIGS. 19A-19B illustrate a points editing page of the platform according to one embodiment of the present invention. FIG. 19A illustrates a point information subsection of the points editing page according to one embodiment of the present invention. The points editing page includes inputs for information relating to a new data point and/or an existing data point wherein the data requires editing. The points editing page includes an overall fetch location data feature as well as individual fetch location data features for each data point. In one embodiment, the points addition feature includes inputs for data collection for data categories (i.e., subsections). Subsections include but are not limited to hydrology, vegetation, soil, and stream behavior according to one embodiment of the present invention. FIG. 19B illustrates the hydrology data subcategory of the points editing page.

In one embodiment, the points editing page of the present invention is used to add a new survey point. One of ordinary skill in the art will appreciate that an editing page of a survey point will include data input at the survey point while the points editing page will include editable data and/or data input features (e.g., check boxes, typed input, slide select). In one embodiment of the present invention, the platform auto-populates a points addition page including but not limited to one or more auto populated data points associated with a client account, user account, location of the survey point, internal project identifier, sampling date, sampling location shorthand identifier. In one embodiment, the present invention includes a fetch location data feature, wherein selecting the fetch location data feature auto-populates information for the point, including but not limited to a location, a Land Resource Region (LRR), a Major Land Resource Area (MLRA), soil map unit name, and NWI classification based on the coordinates provided by the location data.

In one embodiment, the hydrology subcategory includes a list of primary indicators of wetland hydrology and a list of secondary indicators of wetland hydrology. In one embodiment, each indicator listed includes a click-select box, wherein selecting the box indicates the presence of that indicator at the data collection point.

In one embodiment, the list of primary indicators of wetland hydrology includes, but is not limited to, surface water (A1), high water table (A2), saturation (A3), water marks (B2), aquatic fauna (B13), marl deposits (B2), sediment deposits (B2), drift deposits (B3), algal mat of crust (B4), iron deposits (B3), inundation visible on aerial imagery (B7), water-stained leaves (B9), hydrogen sulfide odor (C1), oxidized rhizospheres along living roots (C3), presence of reduced iron (C4), recent iron reduction in tilled soils (C6), and thin muck surface (C7). In one embodiment, the primary indicator codes (e.g., A1, A2) are displayed beside each indicator for the purpose of clarity. In one embodiment, the secondary indicators of wetland hydrology are drainage patterns (B10), moss trim lines (B16), surface soil cracks (B6), sparsely vegetated concave surface (B8), dry season water table (C2), crayfish burrows (C8), saturation visible on aerial imagery (C9), geomorphic position (D2), shallow aquitard (D3), and sphagnum moss (D8). In one embodiment, the secondary indicator codes (e.g., B10, D3) are displayed beside each indicator for the purpose of clarity. In one embodiment, each wetland hydrology indicator includes an information tile, wherein selecting the information tile generates a photographic display of the wetland hydrology indicator for which the information tile was selected.

In one embodiment, the hydrology subsection of the point editing page includes an auto-calculate option for a FAC-Neutral test, wherein selecting the auto-calculate option enables the platform to automatically conduct the FAC-Neutral test. One of ordinary skill in the art will appreciate the process of the FAC-neutral test in determining the passage or failure of the FAC-neutral test. The present invention is configured to identify the dominant species of each stratum, combine the dominant species of each stratum into a single list, determine the wetland indictor status for each species, eliminate the FAC species, and determine if the number of FACW and OBL species outnumber the number of FACU and UPL in real time.

In one embodiment, the vegetation subsection of the point editing page includes a tree stratum section, a sapling/shrub stratum section, an herb stratum section, a vine stratum section, and hydrophytic vegetation indicators section. The vegetation subsection further includes one or more links to a species entry prompt. In one embodiment, selecting a species entry listing on the vegetation sections via touchscreen or click-select generates a species entry prompt. In one embodiment, a species entry prompt includes a typed entry spaces for the scientific name of a species, wherein the species entry prompt automatically suggests a species from a library of species data saved to the database of the present invention based on the input received by the species entry prompt. The species entry prompt further includes a typed entry space for an absolute percentage of coverage of the species, as well as a drop down menu for selecting the indicator status of the vegetation species (e.g., FAC, FACW). In one embodiment, the tree stratum section includes a data entry option for the plot size of the tree stratum as well as the size unit of the tree plot. The tree stratum section further includes data entry prompts for one or more species of tree. In one embodiment, selecting a data entry prompt for a tree species generates a species entry prompt. In one embodiment, the sapling/shrub stratum section includes a data entry option for the plot size of the sapling/shrub stratum as well as the size unit of the sapling/shrub plot. The sapling/shrub stratum section further includes data entry prompts for one or more species of sapling/shrub. In one embodiment, selecting a data entry prompt for a sapling/shrub species generates a species entry prompt. In one embodiment, the herb stratum section includes a data entry option for the plot size of the herb stratum as well as the size unit of the herb plot. The herb stratum section further includes data entry prompts for one or more species of herb. In one embodiment, selecting a data entry prompt for an herb species generates a species entry prompt. In one embodiment, the vine stratum section includes a data entry option for the plot size of the vine stratum as well as the size unit of the vine plot. The vine stratum section further includes data entry prompts for one or more species of vine. In one embodiment, selecting a data entry prompt for a vine species generates a species entry prompt.

In one embodiment, the soil subsection of the point editing page includes, but is not limited to, a profile description section, an indication as to the presence of hydric soil (i.e., a slide indicator, wherein selecting the slide indicates the presence of hydric soil), a selectable list of hydric soil indicators (i.e., indicator codes for hydric soil), a selectable list of indicators for problematic hydric soil, a typed input prompt for the type and depth of a restrictive layer, and a typed remarks section, wherein the remarks section receives typed input and saves the received input to the database of the present invention. In one embodiment, the hydric soil indicators include but are not limited to Histosol (A1), Histic Epipedon (A2), Black Histic (A3), Hydrogen Sulfide (A4), Stratified Layers (A5), Organic Bodies (A6), 5 cm Mucky Mineral (A7), Muck Presence (A8), 1 cm Muck (A9), Depleted Below Dark Surface (A11), Thick Dark Surface (A12), Coast Prairie Redox (A16), Sandy Mucky Mineral (S1), Sandy Gleyed Matric (S4), Sandy Redox (S5), Stripped Matric (S6), 1Dark Surface (S7), 2 Polyvalue Below Surface (S9), 3 Thin Dark Surface (S9), 4 Loamy Mucky Mineral (F1), 5 Marl (F10), 5 Marl (F10), 7 Iron-Manganese Masses (F12), 8 Umbric Surface (F13), 9 Delta Ochric (F17), 10 Reduced Vertic (F18), Loamy Gleyed Matrix (F2), Anomalous Bright Loamy Soils (F20), Deplated Matric (F3), Redoc Dark Surface (F6), Depleted Dark Surface (F7), and Redoc Depressions (F8). In one embodiment, the indicators for problematic hydric soil include but are not limited to Histosol (A1), Histic Epipedon (A2), Black Histic (A3), Hydrogen Sulfide (A4), Stratified Layers (A5), and Organic Bodies (A6).

In one embodiment, the platform is operable to provide hydric soil indicator suggestions based on location, depth, color, texture, and/or other factors. In one embodiment, the platform provides back color coding to indicate likelihoods of various hydric soil indicators. The platform is further able to provide custom help and guidance inline to help determine accurate indicators while an operator is in the field in both mobile and web application versions.

In one embodiment, the stream behavior subsection of the point editing page includes stream information, stream identification data, stream morphology data, stream habitat data, and riparian zone data. The stream information includes but is not limited to survey name, internal project ID, stream name, sampling date, investigator (e.g., the user account associated with an investigator), the applicant/owner, state where the sample was collected, city/county of the sample collection, section, township, range, latitude, longitude, images/video relating to the sample, and NWI classification. The stream identification data includes but is not limited to the National Hydrology Database (NHD) name of the stream (i.e., if it exists and/or what the name is), the Geographic Names Information System (GNIS) name of the stream, and the classification of the stream. The stream morphology data includes but is not limited to units, bank height (i.e., right and left bank height), water depth, width of the stream at the ordinary high water mark (OHWM) and the top of bank (TOB), stream flow, primary substrate, secondary substrate, and bank type/shape. The stream habitat data includes but is not limited to the presence and/or location of riffles, runs, and/or pools. The riparian zone data includes but is not limited to one or more riparian vegetation species.

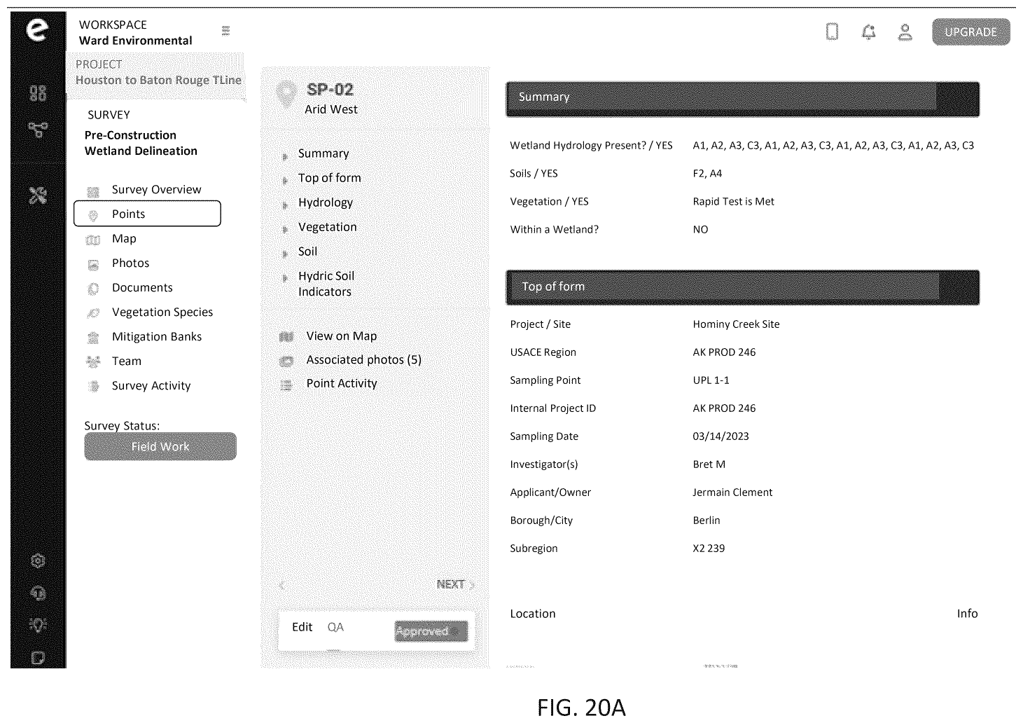

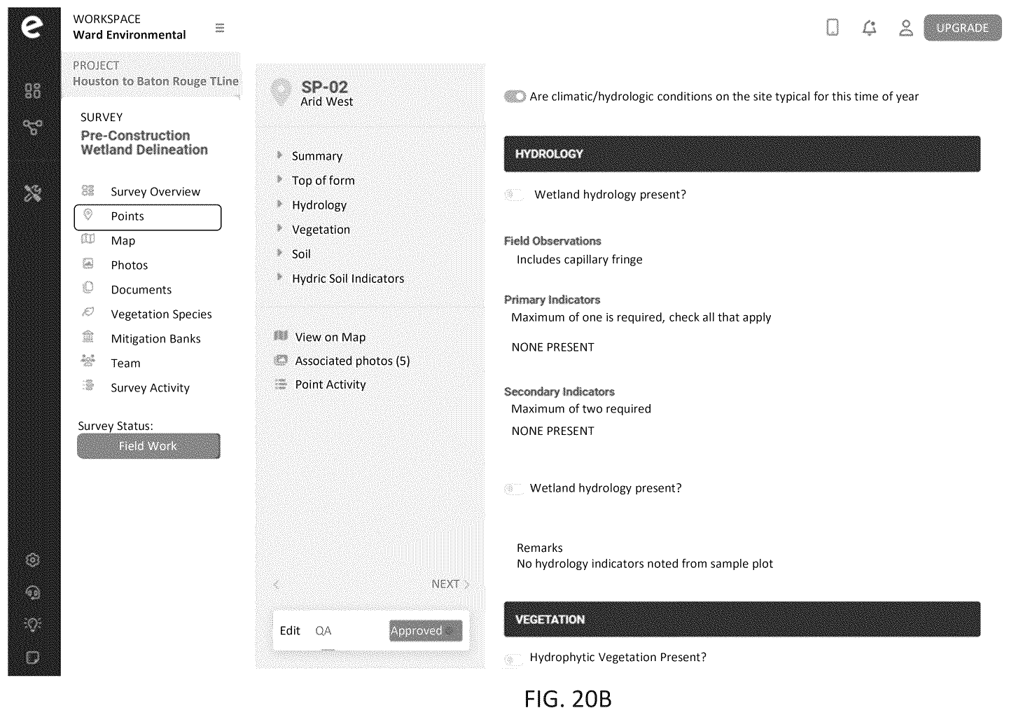

FIGS. 20A-20B illustrate a point review page according to one embodiment of the present invention. The points review page depicted in FIG. 20A displays the summary data category of the data collected by a user account via the data collection functionality of the platform. The specific data categories (i.e., subsections) of the point include but are not limited to the summary, the top of form, hydrology, vegetation, soil, and hydric soil indicators. FIG. 20B illustrates the hydrology subsection of the point review page according to one embodiment of the present invention. The points review page further includes a quick select menu for directions to specific data categories (i.e., subsections) included in the point of the survey. For example, selecting the summary directs an account to the summary subsection of the survey point.

In one embodiment, the point review page includes the information collected by the data collection platform. The collected information is then saved to a database of the present invention and accessible via the platform of the present invention. This allows for quality assurance of the collected data, as an administrator account is operable to review the data collected by the user account and verify that the necessary information has been collected and is accurate (e.g., by determining that the necessary USACE standards for the report format have been met or reviewing the images uploaded by the user account to the database of the present invention for verification of correct identification).

In one embodiment, the summary subsection of the point review page includes an indication of the presence of wetland hydrology, one or more hydraulic indicators for the wetland hydrology, an indication of the presence of hydric soil, one or more field indicators of hydric soil, an indication as of whether the vegetation is hydrophytic, an indication of why the vegetation is classified as hydrophytic (e.g., the rapid test is met), and/or an indication of whether the point is located within a wetland.

In one embodiment, the top of form subsection of the point review page includes the project/site identifier, the USACE region where the data point and/or the survey is located, a sampling point name and/or identifier (e.g., UPL1-1), an internal project ID, a data and/or time associated with the sampling (e.g., sampling date), an investigator (i.e., user associated with a user account), applicant/owner (i.e., a client associated with a client account), a Borough/City wherein the data was collected, and/or a subregion (e.g., x2 239) where the point is located. Subregion codes are operable to be provided using Land Resource Region (LRR) and Major Land Resource Area (MLRA) codes according to one embodiment of the present invention.

In one embodiment, the top of form subsection further includes the location data gathered relating to the point. In one embodiment, the location data gathered relating to the point includes a datum associated with a geographical locating schema (e.g., the World Geodetic System 1984 [WGS84]) for identifying the location of the point, a latitudinal coordinate associated with the data point, a longitudinal coordinate associated with the data point, a landform and/or lookup associated with the point (e.g., aa lava), a local relief, a slope percentage (i.e., slope %), NWI classification, soil map unit name (e.g., “51-High Intermountain Valleys [Colorado and New Mexico]”), and/or an indication of whether the climatic and/or hydraulic conditions on the site of the data point are typical for the time of the year in which data was gathered.

In one embodiment, the hydrology subsection of the point review page includes an indication of the presence of wetland hydrology, one or more field observations (e.g., a text file including typed field observations, an uploaded .PDF file of a written note), one or more primary indicators of wetland hydrology, one or more secondary indicators of wetland hydrology, and/or an indication of the presence of wetland hydrology. In one embodiment, the hydrology subsection of the point review page displays the remarks made by a user account (e.g., displayed text or a text file) when collecting and uploading the data via the data collection functionality of the platform.

In one embodiment, the vegetation subsection of the point review page includes an indication of the presence of hydrophytic vegetation, tree stratum coverage percentage, the plot size of one or more tree stratum, the tree plot size unit (e.g., ft r), herb stratum coverage percentage, the plot size of one or more herb stratum, the herb plot size unit (e.g., ft r), the species of each identified vegetation (i.e., tree, herb, and/or vine), the percent coverage of each identified species, the national wetland plant list indicator status rating for the species, the Unites States Department of Agriculture (USDA) symbol for each vegetation, vine stratum coverage percentage, the plot size of one or more vine stratum, and/or the vine plot size unit (e.g., ft r). In one embodiment, the vegetation subsection of the point review page displays the remarks made by a user account when collecting and uploading the data via the data collection functionality of the platform.

In one embodiment, the soil subsection of the point review page includes an indication of the presence of hydrophytic soil, a profile description of each soil sample, a display of the selected hydric soil indicators, and/or a display of the selected indicators for problematic hydric soil. In one embodiment, the profile description of each soil sample includes the location of an identified soil type from the overall soil sample, the Munsell Soil Color Code for the identified soil type, a screen representation similar to the selected Munsell Soil Color Code to help improve accuracy, the Munsell Soil Color Description for the identified soil type, and the soil layer percentage of the identified soil type. The consideration of FIG. 11 with respect to the soil subsection of the point review page illustrates the interface between a first device performing data collection and data management functionality performed on a second device used for quality assurance and task management. The data collected via the soil line page is saved on a database of the present invention, and is accessible via the platform upon accessing the survey and survey point information saved with respect to the data collection point. The information displayed in the soil subsection of the point review page is the data collected by the data collection platform according to the present invention. This data is operable to be corrected or otherwise before the data is displayed.

In one embodiment, the system of the present invention includes one or more additional point data collection pages including additional data assessments and data intake channels and one or more corresponding point editing pages. These data assessments include but are not limited to state-specific environmental rapid assessments, as well as intake channels for data including threatened and endangered species, forestry, groundwater, and stormwater pollution planning.

The point review page further includes a portal to the media uploaded at the data collection location associated with the point, either at the physical location or uploaded with regard to the data point after data was collected at the data collection location. The point review page includes a portal to the geographical view of the area associated with the survey (e.g., a satellite view) with an overlay indication of the location of the data point. The point review page further includes a portal to the point activity page.

In one embodiment, the point activity page redirects to a subsection of the survey activity page including data relating to that point (e.g., the creation date and/or time). In one embodiment, the survey activity page displays the date and/or time of creation of the survey, the date and/or time of the creation of the point, the date and/or time the survey was assigned to a user account by an administrator account, the date and/or time any data was added to the point, a status change (e.g., assignment to another user account), the date and/or time of any status change, one or more messages between user accounts, and/or one or more messaging portals between users. In one embodiment, the points activity page displays the date and/or time of creation of the survey, the date and/or time of the creation of the point, the date and/or time the survey was assigned to a user account by an administrator account, the date and/or time any data was added to the point, a status change (e.g., assignment to another user account), the date and/or time of any status change, one or more messages between user accounts, and/or one or more messaging portals between users.

In one embodiment, the system of the present invention includes a tagging structure to tag data points with identifiers indicating the type of data included in a data point. These tags are then used to identify data points which are useful for a specific purpose so there is a path to reutilize it in different contexts, even after the eventual anonymizing of the data or the creation of derivative synthetic data as disclosed herein. For example, soil data collected during Wetland Delineation projects is tagged specifically so that it is operable to be applied not only toward different permits, but also pulled out of the context of environmental permitting and generalized as high-level soil data to be analyzed at scale across a region. In this way, the AI engine of the present invention is operable to analyze the generalized, high-level soil data for a given region to generate an output.

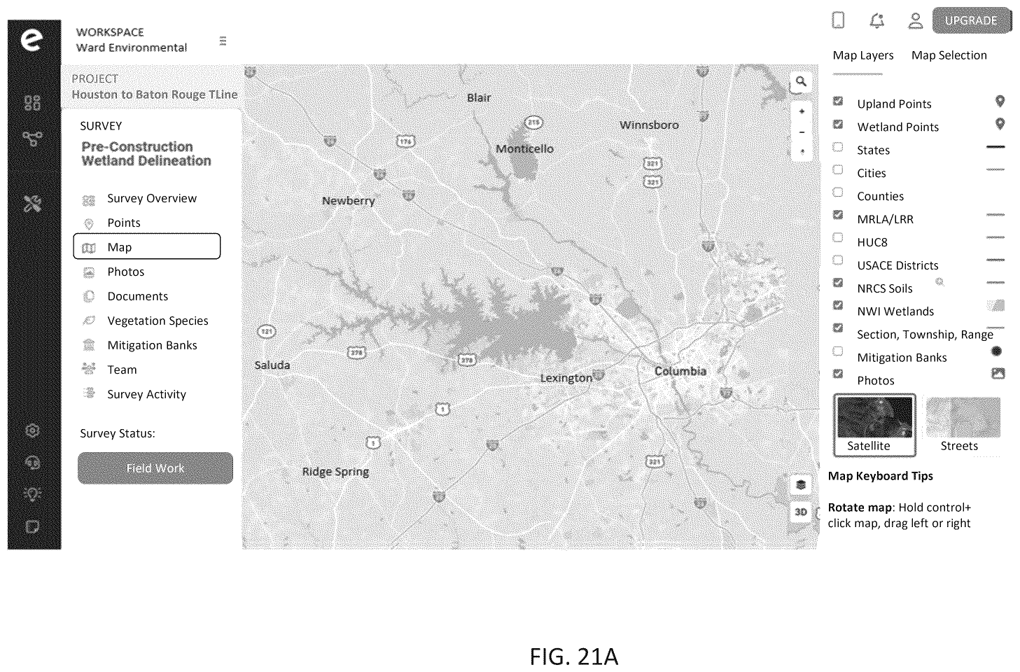

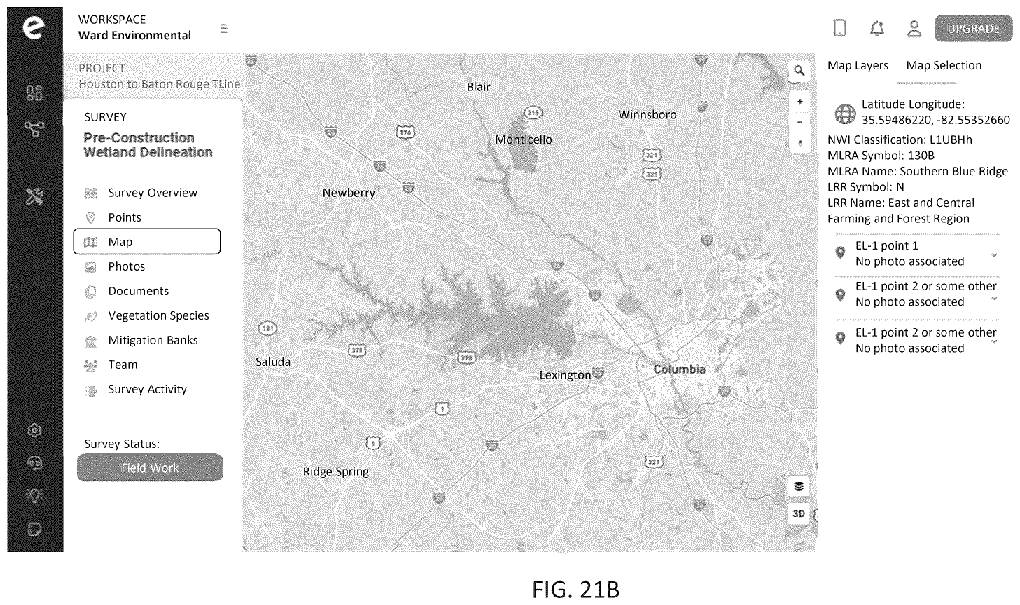

FIGS. 21A-21B illustrate a geographic visualization page for a survey according to one embodiment of the present invention. FIG. 21A illustrates a map with layering functionality according to one embodiment of the present invention. The layering functionality depicts the geographic visualization including one or more overlays, icons, and identifiers to indicate the features of the geographic area identified by the platform of the present invention and/or one or more geographic positioning systems. FIG. 21B illustrates the information included in the map selection of the geographic visualization page according to one embodiment of the present invention. The geographic visualization is operable to include a satellite visualization and/or a streets visualization of the geographic area of interest.

In one embodiment, the system of the present invention incorporates publicly available datasets into the map viewer to analyze the collected data and evaluate the impact of the data. Examples of publicly available datasets include but are not limited to Land Use Land Cover (LULC), National Wetlands Inventory (NWI), National Hydrology Database (NHD), Conserved Lands, Public lands, Utilities, and Protected Species. In one embodiment, the geographic visualization page of the present invention includes one or more overlays, icons, and identifiers to indicate the features of the geographic area. Examples of these features include but are not limited to upland points, wetland points, states, cities, counties, MLRA/LRA, Hydraulic Unit Codes (HUC), USACE districts, NRCS soils, National Wetlands Inventory (NWI) wetlands, section, township, range, mitigation banks, existing mitigation banks with watershed-level and/or media collected at one or more data points. In one embodiment, the Hydraulic Unit Codes (HUC) of the present invention include HUC-10 as an indication of the watershed level of the mitigation bank. In one embodiment of the present invention, the geographic visualization page of the present invention includes FEMA Flood Hazard mapping, visualization of available mitigation banks (pre-existing and/or identified), and a mitigation bank site sustainability index.

In one embodiment, the geographic visualization page of the present invention includes the latitudinal and longitudinal coordinates, NWI classification, MLRA symbol, MLRA name, LRR symbol, LRR name, and/or media (e.g., a photo) for the identified survey and/or a specific data collection point of the survey. In one embodiment, the geographic visualization page includes drop down displays which, upon receiving a touch screen or click-select input, display the latitudinal and longitudinal coordinates, NWI classification, MLRA symbol, MLRA name, LRR symbol, LRR name, and/or media (e.g., a photo) for the survey point.

In one embodiment of the present invention, the geographic visualization page includes a three-dimensional (3-D) rendering of the geographical area associated with the survey. In one embodiment, the 3-D rendering is an aerial view of the geographic area of interest for the survey. In one embodiment, the 3-D rendering is a street-level view of the geographic area of interest for the survey. In one embodiment, the geographic area visualized on the geographic visualization page is not the geographic area associated with an existing survey. In one embodiment, the geographic area visualized on the geographic visualization page is a geographic area associated with a proposed survey. The 3-D rendering is operable to be provided using a custom software or one or more third-party software, such as MAPBOX. U.S. Pat. No. 10,775,174 describes one embodiment of creating 3-D renderings and is incorporated herein by reference in its entirety.

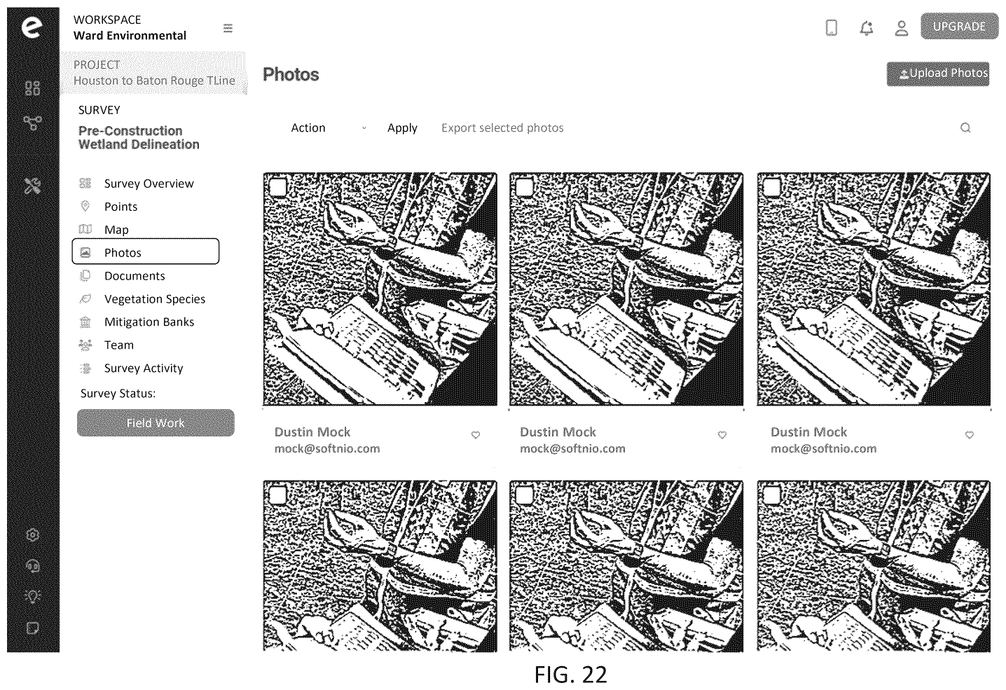

FIG. 22 illustrates a media gallery page according to one embodiment of the present invention. The media gallery includes one or more media files uploaded to the database of the platform. The platform then accesses the database containing the uploaded media and displays the media in the media gallery page associated with the survey. The media gallery displays the uploaded media, the user account from which the media was uploaded to the database. The media gallery features a search functionality wherein an administrator account (or user account using the platform) is operable to search for specific media (e.g., by user account which uploaded the media, date of upload, etc.). The media gallery includes an upload function, wherein a user account of the platform or an administrator account is operable to upload one or more files to the database for access via the platform of the present invention. The media gallery includes an option to mark specific files as favorites. The media gallery also includes an export function to enable the sharing of media collected via the platform of the present invention with third-party platforms and devices. Each media includes a select option wherein the platform receives a selection of one or more media. Selecting one or more media via touch screen or click select enables a user to apply a function to multiple files (e.g., export multiple files).

The term “media” as used herein refers to images, videos, audio, and legible documents. Exemplary image file types operable for upload to the platform of the present invention include but are not limited to .JPEG, .JPG, .PNG, .GIF, WebP, .TIFF, .BMP, .HEIF, .SVG, .EPS, .PDF, .PSD, .AI, .XCF, .INDD, and raw image file types. One of ordinary skill in the art will appreciate that the platform of the present invention is not limited to image file types and is operable to upload video files and audio files to the database of the present invention. Exemplary video file types operable for upload by the platform of the present invention include but are not limited to .M4V, .SVI, .3GP, .3G2, .FLV, .F4V, .F4P, .MPG, .MPV, AND .GIFV. Exemplary audio file types operable for upload by the platform of the present invention include but are not limited to .MP3, .WAV, .MP4, .FLAC, .ALAC, and .WMA.

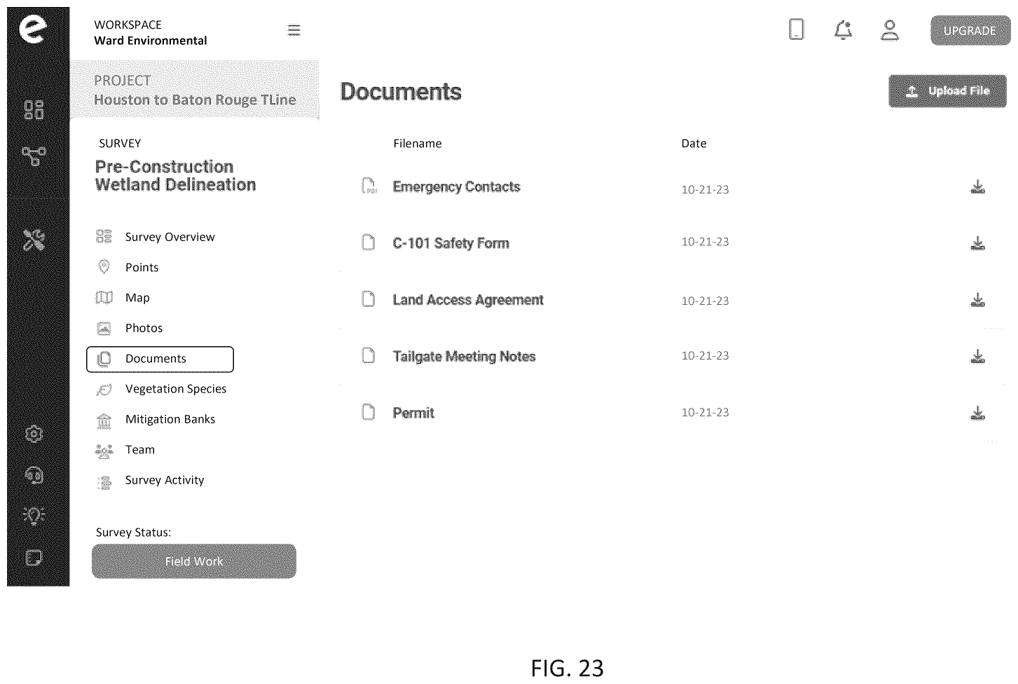

FIG. 23 illustrates the documents page of the platform according to one embodiment of the present invention. The documents page includes a list of documents uploaded to the database of the present invention via the platform of the present invention. The list includes a file name of the document, a data and/or time the document was uploaded, a download function to download the document from the platform of the present invention, and an option to upload a document file to the database of the present invention.

Exemplary document file types operable for upload by the platform of the present invention include but are not limited to .DOC, .DOCM, .DOCX, .DOT, .DOTM, .DOTX, .HTM, .HTML, .MSG, .PDF, .RTF, .TXT, .WPD, .XHTML, and .XPS. One of ordinary skill in the art will appreciate that the file types disclosed herein are not intended to be exhaustive, but are disclosed to exemplify certain features and functions of the present invention.

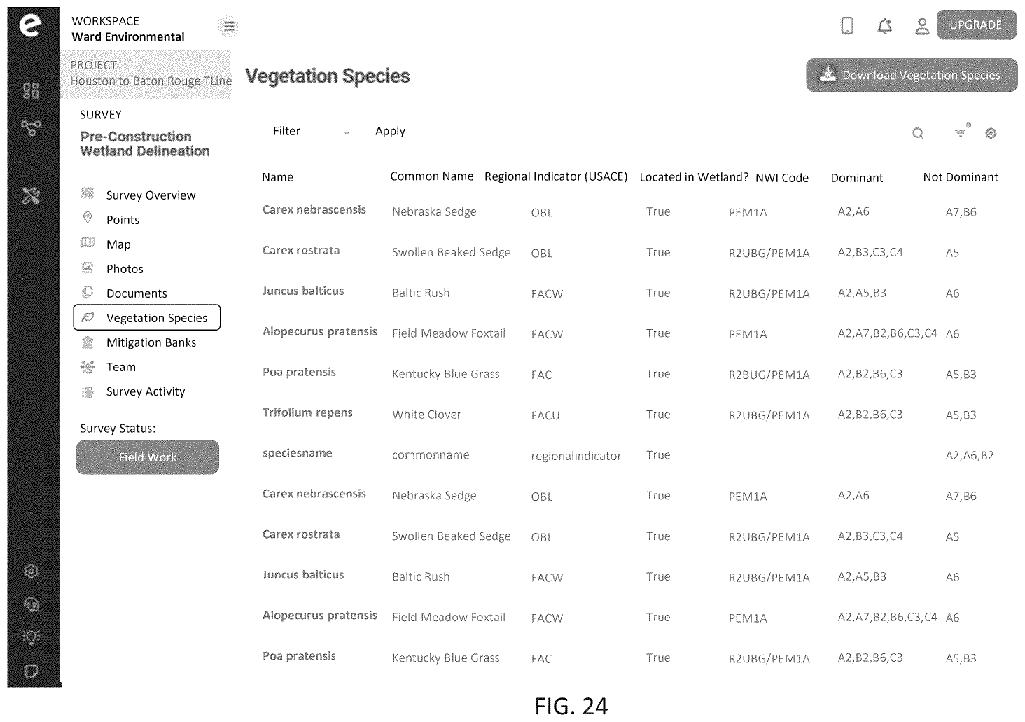

FIG. 24 illustrates a vegetation species page of the platform of the present invention. The vegetation species page includes a list of the species of vegetation identified and recorded at the data collection point or identified via the platform upon review of the media uploaded via the platform. The vegetations species page includes a filter to organize the displayed specific vegetation species and a search bar to locate a desired vegetation species form the list. The vegetation species page includes a download feature to download the list of vegetation species and/or one or more individual vegetation species selected from the list.

In one embodiment, the vegetation species list includes the species name of the vegetation, the common name, regional indicator as classified by the USACE, an indication of whether the vegetation is located in a wetland, the NWI code, the dominant vegetation indicators, and the vegetation indicators that are not dominant. Information relevant for wetland delineation and wetland determination are provided in the Corps of Engineers Wetlands Delineation Manual by Environmental Laboratory, published by U.S. Army Corps of Engineers (Waterways Experiment Station) in its Wetlands Research Program Technical Report Y-87 published in 1987, which is incorporated herein by reference in its entirety. The Regional Supplements to Corps Delineation Manual provide additional region specific detail on wetland determination and wetland delineation (available at https.//www.wsace.army.mil/Missions/Civil-Works/Regulatory-Program-and-Permits/reg_supp/). Each Regional Supplement is incorporated herein by reference in its entirety.

In one embodiment, the search bar of the vegetation species page receives an input via the search function of the vegetation species page of a species name, the common name, regional indicator, the NWI code, the dominant vegetation indicators, and the vegetation indicators that are not dominant. The platform then organizes the list of vegetation species according to the identified filter parameters.

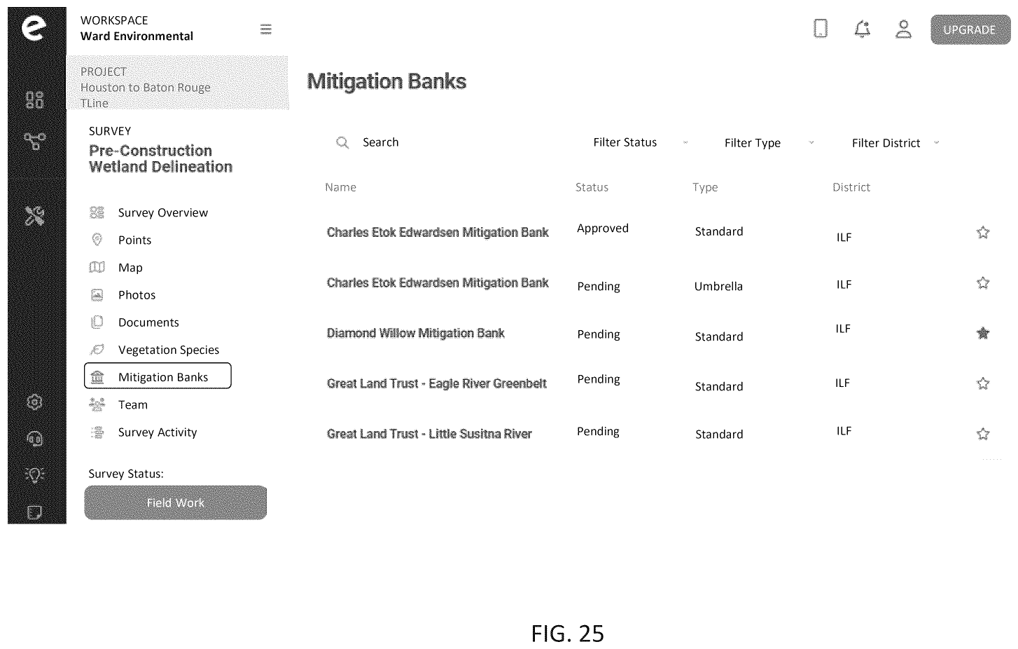

FIG. 25 illustrates the mitigation banks page of the platform according to one embodiment of the present invention. The mitigation banks page includes a searchable list of the mitigation banks associated with a survey and/or project. The mitigation banks page includes a search function operable to receive a typed, click select, or touchscreen input for identifying one or more mitigation banks. The mitigation bank page includes a filter status menu, filter type menu, and filter district menu.

In one embodiment, the list of mitigation banks includes the name of the mitigation bank, the status of the mitigation bank, the type of the mitigation bank, the district, and a favorite function to identify mitigation banks that are of note to an administrator account. The status of the mitigation banks include “pending status” mitigation banks for surveys and/or projects that are not completed or approved and “approved status” mitigation banks for surveys and/or projects that have been approved. In one embodiment, approved status is granted upon approval of the survey by the USACE.

In one embodiment, the search function receives a typed, click select, or touchscreen input of the name of a mitigation bank, the status of a mitigation bank, the type of a mitigation bank, and/or the district of the mitigation bank. Upon receiving the selection, the platform identifies the relevant mitigation banks associated with the search parameters. In one embodiment, the filter status menu includes a drop down selection including options to filter the list by pending status, approved status, or all available status descriptions. In one embodiment, the filter type menu includes a drop down selection including options to filter the list by standard mitigation bank types, umbrella mitigation bank types, or all available mitigation bank types. In one embodiment, the filter district menu includes a drop-down selection including options to filter the list by one or more districts associated with a mitigation bank (e.g., ILF district).

The present invention determines the available mitigation banks within a geographical area of interest and displays the available mitigation banks to the platform of the present invention. By enabling the tracking and reporting of the environmental conditions of the geographic area of interest, the present invention is operable to determine the trajectory of ecosystem impact of the geographic area of interest. The present invention evaluates the environmental conditions of the geographic area of interest, including the hydrology, soil, vegetation, location, and other factors to determine the viability of the geographic area of interest as a mitigation bank.

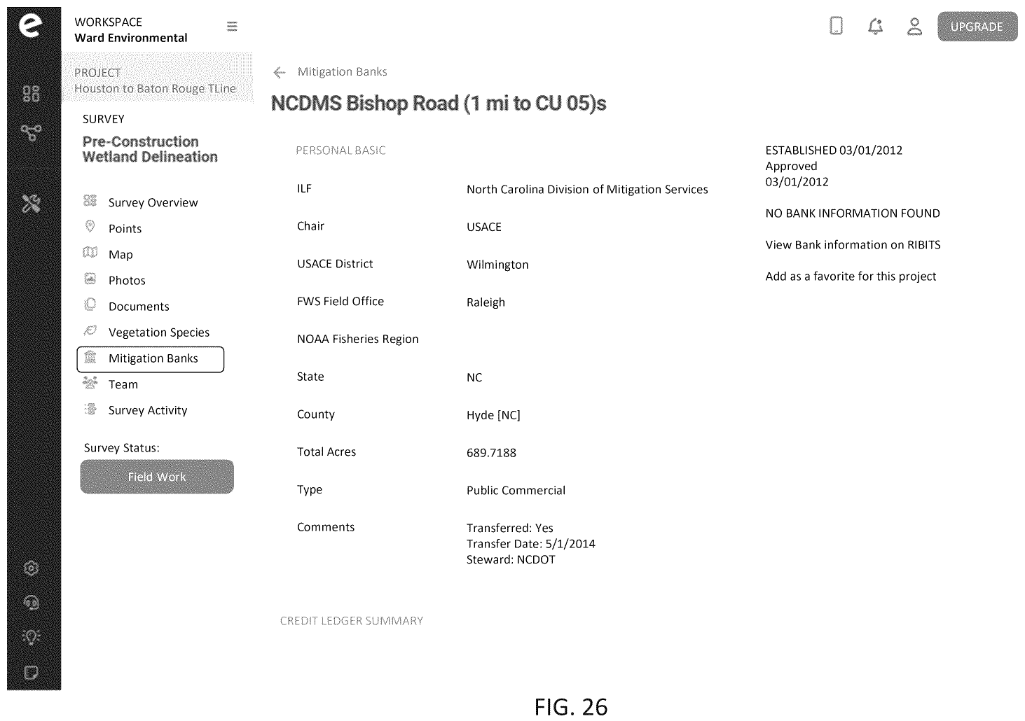

FIG. 26 illustrates a mitigation bank details page according to one embodiment of the present invention. The mitigation bank details include the personal basic details of the mitigation bank. The mitigation bank details page includes the date of establishment of the mitigation bank, the date of the approval of the mitigation bank, available bank information, a link to a source for available bank information, and an option to add the mitigation bank as a favorite for a project associated with the mitigation bank.

In one embodiment of the present invention, the personal basic information of the banks details page includes the regulatory agency associated with the In-lieu Fee (ILF) mitigation program for the mitigation bank, the governing body of the identified regulatory agency, the USACE district, the FWS field office, the National Oceanic and Atmospheric Administration (NOAA) Fisheries region, the state where the survey was conducted, the county wherein the survey was conducted, the total acre coverage of the mitigation bank, the type of the mitigation bank, and any comments included in the mitigation bank. In one embodiment, the comments include the transfer status of the mitigation bank, the date of any transfer, and the steward of the mitigation bank (e.g., NCDOT). In one embodiment, the mitigation banks details page includes the credit ledger summary associated with a mitigation bank.

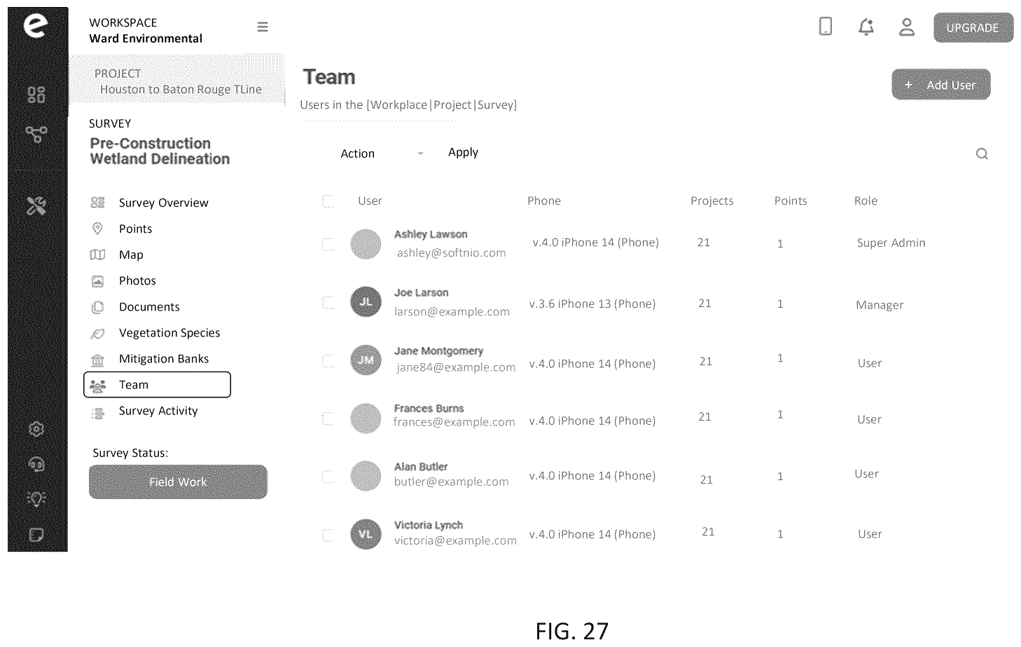

FIG. 27 illustrates the team page of the platform according to one embodiment of the present invention. The team page includes a list of the accounts associated with the platform of the present invention. Each account listing includes the name of the user associated with the account, the email associated with the account, the phone model and version associated with the account, the number of projects associated with the account, the points associate with the account, and the role associated with the account, also referred to as the account type (e.g., user account). The team page includes the option to add a user account to the system of the present invention. A search feature of the teams page allows a user account to identify individual user accounts based on input search parameters.

The add user option of the platform allows for the creation of a user account according to the system of the present invention. In one embodiment of the present invention, any account created via the platform automatically enables an account to be created via the platform of the present invention. For example, user account A is created via the platform and saved to the database of the present invention. User account A is then assigned Survey X. Upon receiving the login information for user account A, the data collection platform signs into the account created via the platform and generates the dashboard of the user account including Survey X, despite not receiving an “add project” input via the user device implementing the platform.

In one embodiment, the search feature of the teams page is configured to receive an input of a name of a user associated with an account, an email associated with an account, a phone model and version associated with the account, a number of projects associated with an account, a number of points associate with an account, and/or a role associated with an account. The search feature is configured to identify matching information within the list of accounts in order to populate the account list with the desired account.

In one embodiment, the team page includes a list of all user accounts associated with a company workspace (e.g., Ward Environmental). In one embodiment, the team page includes a list of all user accounts associated with the project. In one embodiment, the team page includes a list of all user accounts associated with the survey.

The role associated with each account serves to identify the hierarchical role of each account. In one embodiment, each account type is operable to utilize every function of the platform. In one embodiment, a user account is not operable to assign a project, survey, or point to another user account. In one embodiment, an administrator account (i.e., a manager account type or super admin account type) is operable to assign a project, survey, or point to any account type. In one embodiment, a manager account is operable to assign a project, survey, or point to a user account. In one embodiment, a manager account is not operable to assign a project, survey, or point to a super admin account. In one embodiment, a super admin account is operable to assign a project, survey, or point to a user account or a manager account. In one embodiment, a super admin account is operable to assign a project, survey, or point to any account type.

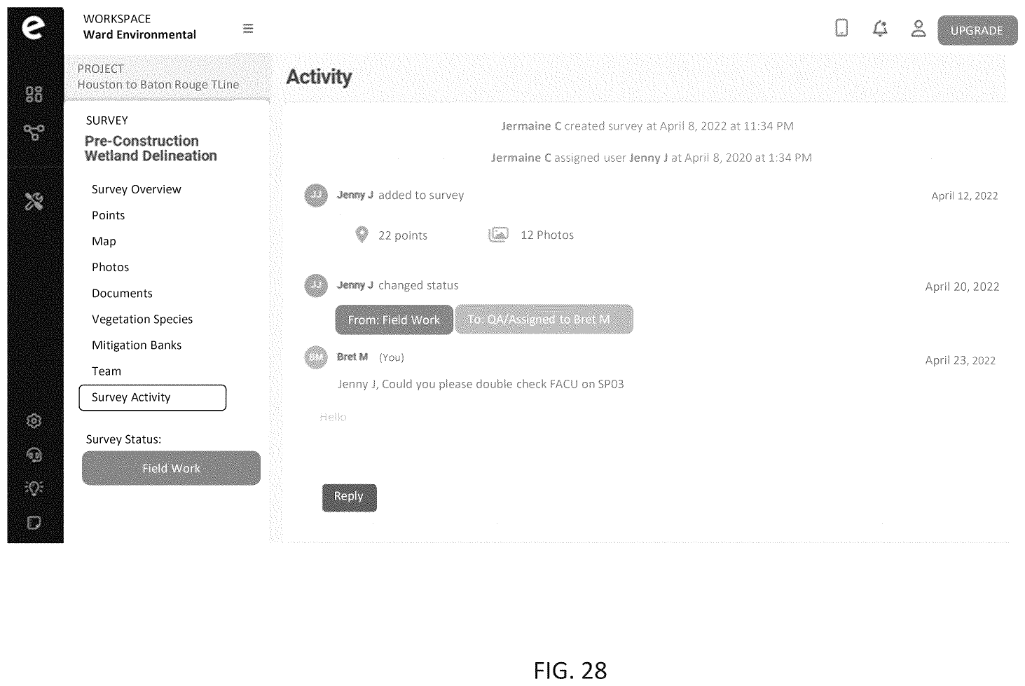

FIG. 28 illustrates a survey activity page of the platform according to one embodiment of the present invention. The survey activity page includes a detailed list of each action taken via the platform of the present invention. The survey activity page includes the date and time of the creation of the survey, the date, time, and user account to which the survey was assigned, any data added to the survey via the platform, any media added to the survey via the platform, and any change in survey status. The survey activity page includes a comment option, operable to receive messages and display the message in the survey activity. In one embodiment, messages sent via the messaging portal of the platform are saved to the database of the present invention and thereby accessible and subsequently viewable on the platform. In one embodiment, activity performed with regard to the survey (e.g., media upload, status changes) are automatically included in the activity page of the present invention.

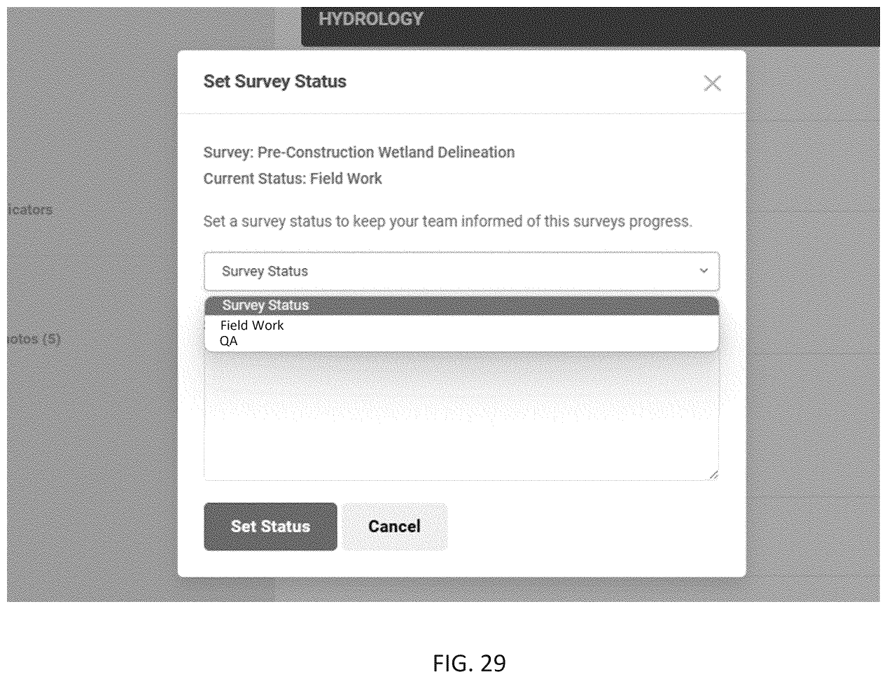

FIG. 29 illustrates a set survey status page according to one embodiment of the present invention. The set survey status page includes a drop down menu of the status options available for a survey. The set survey page feature includes a text input section wherein one or more comments are saved with respect to the survey status change.

The set survey status page is generated upon selection of the survey status feature of the survey overview page. In one embodiment, changing the status of the survey of the present invention from Field Work to Quality Assurance (QA) automatically reassigns the survey to an administrator account associated with the survey. In one embodiment, a change in the survey status is automatically saved to the survey activity page of the present invention. In one embodiment, the survey is only operable to be edited by a user account when the survey status is set to Field Work. In one embodiment, the survey is operable to be edited by an administrator account of the present invention even if the survey status is set to field work. In one embodiment, survey status is automatically set to Field Work upon checkout of the survey by a user account via the platform of the present invention.

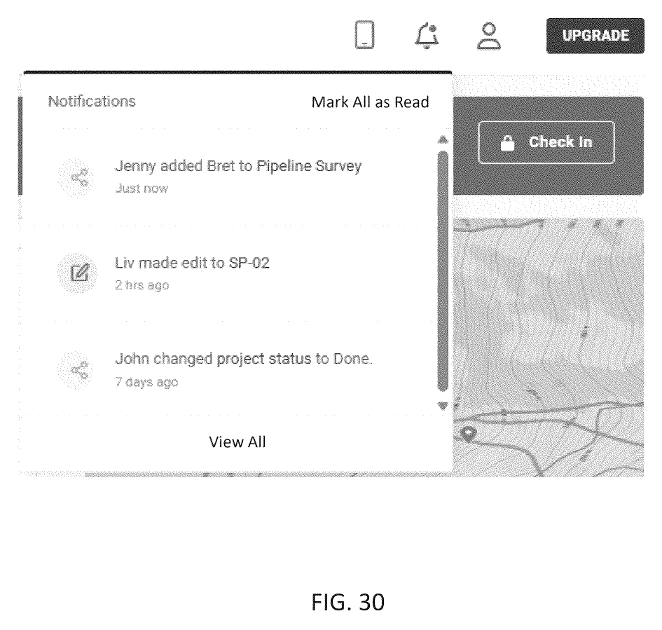

FIG. 30 illustrates a notifications feed according to one embodiment of the present invention. The notifications feed is generated upon selection of the notifications icon displayed on the platform of the present invention. The notifications feed includes notifications of the activity made with regard to one or more projects.

In one embodiment, the notifications feed displays each action taken with regard to a survey. In one embodiment, the notifications feed displays each action taken with regard to a project. In one embodiment, the notifications feed displays each action taken with regard to a company (e.g., actions listed for both the Houston to Baton Rogue TLine Project and King Street Distribution Circuit A5292 Project). In one embodiment, the notifications feed displays the user accounts and administrator accounts associated with each action taken with regard to a survey and/or project (e.g., User Account Liv made edit to SP-02). In one embodiment, the notifications feed displays the date and time of each action taken with regard to a survey.

The term “action” as used herein refers to activity of a user account or administrator account via the platform, including but not limited to the upload or editing of any data, media, or documents to the database of the present invention, as well as any change in assignment of the survey or project, change in the status of the survey or project, and addition of a point, survey, or project.

In one embodiment, the system of the present invention is configured to automatically format the collected information into a regulatory permitting form for submission to a government or authority responsible for granting the permit. In one embodiment, the platform is configured to include prompts for data points which are not considered for regulatory permitting for all report formats. In one embodiment, the platform is configured to include prompts for all data points which are considered for regulatory permitting for any report format. For example, data point A is not necessary for Report 1, but is considered in Report 2. The platform prompts for the collection of data point A to ensure that manually re-collecting or reevaluating a certain data point is not required for a single project, even if the project (i.e., the report format) changes. The present invention is configured to reallocate data to a variety of report formats to eliminate the re-collection that is necessitated by prior art platforms and systems when changing report types.

In one embodiment, the AI engine of the present invention is operable to automatically generate a summary and analysis of the collected data, the regulatory permitting report, or observations of user activity by the platform

In one embodiment, the system of the present invention is configured to export one or more reports to a data storage system of a user device or software. The report file is exported in a file format. Examples of operable file formats for exporting the report of the present invention include but are not limited to a PDF of the permit form, a CSV file, a GeoJSON file, or a shapefile. In one embodiment, the exported report is operable to include one or more supplemental files (e.g., satellite data, image files from the user device, etc.) for inclusion in a permitting report.

In one embodiment, the system of the present invention includes a data warehouse for the storage of historical data and future analysis. Upon submitting the formatted report including the collected, the present invention is configured to transmit the collected data from the database of the present invention to the data warehouse. In one embodiment, the data is aggregated within the data warehouse according to the Hydrologic Unit Code (HUC) hierarchy. In one embodiment, the data is aggregated within the data warehouse according to HUC8 (i.e., the subbasin level). In one embodiment, the data is aggregated within the data warehouse according to HUC2 (i.e., the regional level), HUC4 (i.e., the subregional level), HUC6 (i.e., the basin level), HUC12 (i.e., the local sub-watershed level).

In one embodiment, the data is anonymized before being stored in the data warehouse. Data anonymization is accomplished using a variety of methods, including but not limited to character shuffling, encryption, and term or character substitution. In one embodiment, all personally identifiable information is removed from the data during the anonymization step, thereby reducing the risk of unintended disclosure of sensitive or personal information. In one embodiment, data relating to the user account, the manager account, administrator account, or other account types integrated into the system of the present invention. The anonymized data is then stored in the data warehouse in a predetermined schema of organized datasets for streamlined access and analysis by an artificial intelligence engine. The present invention is operable to utilize a blockchain architecture for anonymizing data, such as the architecture described in US Patent Pub. No. 20180349896, which is incorporated herein by reference in its entirety. In one embodiment, data is anonymized and blockchain is utilized for data integrity and showing the chain of custody for validation purposes. In one embodiment, new synthetic data is derived from the collected data to produce a novel dataset that is both scientifically accurate and useful, but does not reflect any actual private data or private property information.

The computer system of the present invention is operable to utilize a plurality of learning techniques including, but not limited to, machine learning (ML), artificial intelligence (AI), deep learning (DL), neural networks (NNs), artificial neural networks (ANNs), support vector machines (SVMs), Markov decision process (MDP), and/or natural language processing (NLP). The system is operable to use any of the aforementioned learning techniques alone or in combination.

The system is operable to utilize predictive analytics techniques including, but not limited to, machine learning (ML), artificial intelligence (AI), neural networks (NNs) (e.g., long short term memory (LSTM) neural networks), deep learning, historical data, and/or data mining to make future predictions and/or models. The system is preferably operable to recommend and/or perform actions based on historical data, external data sources, ML, AI, NNs, and/or other learning techniques. The system is operable to utilize predictive modeling and/or optimization algorithms including, but not limited to, heuristic algorithms, particle swarm optimization, genetic algorithms, technical analysis descriptors, combinatorial algorithms, quantum optimization algorithms, iterative methods, deep learning techniques, and/or feature selection techniques.

These learning techniques are operable to be utilized on the data stored on the platform and specific data for a proposed or new project for preliminary site assessments. A large language model (LLM) is operable to be utilized to generate risk assessments for new projects based on inputs including a parcel identification, map layer data, and customer specific documents.

In one embodiment, the system of the present invention includes data modeling functionality for the generation of insights and dynamic prediction of ecosystem and biodiversity impact. In one embodiment, the system of the present invention implements one or more algorithms to analyze data at scale, identify relationships within data, and extrapolate implications. In one embodiment, the organizational schema of the data warehouse is configured to store the data according to the relationships identified between data points. In one embodiment, the data modeling provides for display of the collected and analyzed data as authoritative datasets (i.e., certified as having come directly from the creator or authoritative source). The collected data relates to site conditions in the context of local ecosystems and provides updates in real-time as additional data feeds into the platform.

In one embodiment, the data modeling functions of the present invention are configured to integrate the collected, authoritative datasets with external datasets and imagery, including but not limited to Land Use Land Cover (LULC), Normalized Difference Vegetation Index (NVDI), drone, satellite, Light Detection and Ranging (LiDAR), and uploaded image files (e.g., JPEG, PNG, IMG). In one embodiment, the data modeling functions of the present invention verify the authenticity and/or provenance of the external datasets incorporated into the authoritative datasets collected via the system of the present invention. This ensures that the present invention provides data modeling that is highly accurate and representative of the ecosystem corresponding to the datasets.

In one embodiment, the system of the present invention is configured to the data into various datasets, including but not limited to general vegetation data, hydrology data, generalized stream data, and general protected species data. The system is configured to enable the examination and identification of the presence of vegetation species at county level and compare against USACE plant list mappers (e.g., the National Wetland Plant List, or NWPL) and identify outliers. The system is configured to isolate generalized hydrology data and generalized stream data, compare mapped streams and OHWM indicators against NHD mapped features, use LiDAR and satellite imagery to compare mapped boundaries of streams and OHWM, isolate stream quality and properties to determine support of aquatic life, and use precipitation data from NOAA to predict runoff and flood potential from streams based off of stream morphology, vegetation, surrounding geology, and surrounding site characteristics. The system is further configured to isolate general protected species data to track biodiversity of fauna and enable qualitative and quantitative assessment of fauna population, habitat, and food sources (e.g. protected bats and their potential habitat (roost trees and caves). In one embodiment, the system of the present is configured to track biodiversity of reptiles and amphibians and their habitats (e.g., clear or turbid waters, pools in streams, headwaters, cobblestone stream beds). Upon identifying these datasets, the present invention is configured to implement one or more models for predicting ecosystem and biodiversity changes over time. This model is operable to be either a parametric, semi-parametric, or non-parametric. In one embodiment, the prediction model is incorporated into an AI engine. In one embodiment, the Al engine is configured to incorporate a deep-learning learning neural network.

Neural networks, also known as artificial neural networks (ANNs) or simulated neural networks (SNNs), are a subset of machine learning and are at the heart of deep-learning algorithms. Artificial neural networks (ANNs) are comprised of node layers, comprising an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network.

Neural networks rely on training data to learn and improve their accuracy over time and are fine-tuned using a variety of feedback mechanisms and training simulations. Upon fine-tuning the neural network for accuracy, the network is operable to be used to classify and cluster data at a high velocity. In one embodiment, the present invention utilizes training datasets to develop the AI engine of the present invention. For example, a training user of the data modeling receives input via a touchscreen a prompt for a predictive model of the flood potential of a grasslands ecosystem given X change, and the network generates a predictive model of terrestrial ecosystem given a particular change. The network is operable to receive an input from the training user indicating that an incorrect dataset was used and indicates the correct data set to use. When a client user then prompts for a predictive model of the flood potential of a grasslands ecosystem given the particular change, the network generates a predictive model using the correct dataset indicated by the training user. In one embodiment, the neural network of the present invention is trained using an expert group of users that provide feedback on the dynamically generated predictions. In one embodiment, the neural network of the present invention is trained using a backpropagation method as disclosed herein.

In some embodiments, each individual node as its own linear regression model, composed of input data, weights, a bias (or threshold), and an output. Once an input layer is determined, weights are assigned. These weights help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming the input of the next node. This process of passing data from one layer to the next layer defines this neural network as a feedforward network. Larger weights signify that particular variables are of greater importance to the decision or outcome.

Some deep neural networks are feedforward, meaning they flow in one direction only,

from input to output. However, a model is also operable to be trained through backpropagation (i.e., move in the opposite direction from output to input). Backpropagation allows for the calculation and attribution of an error associated with each neuron, allowing for the appropriate adjustment and fitting of the parameters of the models.

In machine learning, backpropagation is an algorithm for training feedforward neural networks. Generalizations of backpropagation exist for other artificial neural networks (ANNs), and for functions generally. These classes of algorithms are all referred to generically as “backpropagation”. In fitting a neural network, backpropagation computes the gradient of the loss function with respect to the weights of the network for a single input-output example, and does so efficiently, unlike a naive direct computation of the gradient with respect to each weight individually. This efficiency makes it feasible to use gradient methods for training multilayer networks, updating weights to minimize loss; gradient descent, or variants such as stochastic gradient descent, are used. The backpropagation algorithm works by computing the gradient of the loss function with respect to each weight by the chain rule, computing the gradient one layer at a time, iterating backward from the last layer to avoid redundant calculations of intermediate terms in the chain rule; this is an example of dynamic programming. The term backpropagation strictly refers only to the algorithm for computing the gradient, not how the gradient is used; however, the term is often used loosely to refer to the entire learning algorithm, including how the gradient is used, such as by stochastic gradient descent. Backpropagation generalizes the gradient computation in the delta rule, which is the single-layer version of backpropagation, and is in turn generalized by automatic differentiation, where backpropagation is a special case of reverse accumulation (or “reverse mode”).

The datasets of the present invention comprise an expert network learning layer used to inform and train the AI engine. Additionally, the system of the present invention continuously imports new, updated ground-truth data collected in the field. This allows the system to incorporate real-time information and continually evolving data into the modeling process. Some existing prior art systems combine multiple datasets based on user input, but crucially lack a continuously evolving layer of ground-truth data received from the field. Additionally, these prior art systems do not produce automated analyses for dynamic evaluation of conservation and biodiversity impact.

In one embodiment, in addition to being able to be used for wetlands, the system of the present invention is able to be used for streams or streambeds, as well as other bodies of water.

In one embodiment, the system of the present invention is able to be used for wetlands monitoring.

FIG. 31 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 31, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate via communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 31, is operable to include other components that are not explicitly shown in FIG. 31, or is operable to utilize an architecture completely different than that shown in FIG. 31. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Location data is created in the present invention using one or more hardware and/or software components. By way of example and not limitation, location data is created using the Global Positioning System (GPS), low energy BLUETOOTH based systems such as beacons, wireless networks such as WIFI, Radio Frequency (RF) including RF Identification (RFID), Near Field Communication (NFC), magnetic positioning, and/or cellular triangulation. By way of example, location data is determined via an Internet Protocol (IP) address of a device connected to a wireless network. A wireless router is also operable to determine identities of devices connected to the wireless network through the router, and thus is operable to determine the locations of these devices through their presence in the connection range of the wireless router.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for environmental field data collection, management and reporting, comprising:
a server platform in network communication with one or more user devices;
wherein the server platform is operable to receive data points from the one or more user devices, and wherein the data points include geolocation data for where each data point was collected;
wherein the data points further include information regarding vegetation, soil, and/or streams proximate to the data points;
wherein the server platform is operable to receive one or more images of vegetation associated with one or more of the data points and utilize artificial intelligence-based matching to identify one or more species of plants in the one or more images of vegetation;
wherein the server platform is operable to generate one or more polygons delineating a wetland area based on connecting three or more of the data points;
wherein the server platform is configured to generate a map interface to display on the one or more user devices based on satellite imagery data for an area; and
wherein the server platform is configured to overlay the data points and/or the one or more polygons on the map interface for the area.

2. The system of claim 1, wherein the server platform is operable to receive inputs from the one or more user devices to edit the one or more polygons.

3. The system of claim 1, wherein the server platform includes a database including surveys and/or reports associated with one or more delineated wetland areas.

4. The system of claim 1, wherein the server platform displays primary indicator codes for wetland hydrology associated with each data point and/or each delineated wetland area.

5. The system of claim 1, wherein the map interface is further operable to display and mark one or more other geographical features.

6. The system of claim 1, wherein the map interface includes a rendering of the area.

7. The system of claim 1, wherein the server platform includes a search functionality operable to receive search terms for media items uploaded to the server platform.

8. The system of claim 1, wherein the server platform overlays a database from the USACE RIBITS system, including one or more mitigation banks associated with each wetland area.

9. A method for wetland delineation, comprising:
a server platform communicating with one or more user devices;
the server platform receiving data points from the one or more user devices, wherein the data points include geolocation data for where each data point was collected;
the data points further including information regarding vegetation, soil, and/or streams proximate to the data points;
the server platform receiving one or more images of vegetation associated with one or more of the data points and utilizing artificial intelligence-based matching to identify one or more species of plants in the one or more images of vegetation;
the server platform generating one or more polygons delineating field conditions;
the server platform generating a map interface to display on the one or more user devices based on satellite imagery data for an area; and
the server platform overlaying the data points and/or the one or more polygons on the map interface for the area.

10. The method of claim 9, further comprising the server platform receiving inputs from the one or more user devices to edit the one or more polygons.

11. The method of claim 9, further comprising a database including surveys and/or reports associated with one or more delineated wetland areas.

12. The method of claim 9, further comprising the server platform displaying primary indicator codes for wetland hydrology associated with each data point and/or one or more delineated wetland areas.

13. The method of claim 9, further comprising the map interface displaying and marking one or more other geographical features.

14. The method of claim 9, wherein the map interface includes a rendering of the area.

15. The method of claim 9, further comprising a search functionality receiving search terms for media items uploaded to the server platform.

16. The method of claim 9, further comprising a database including one or more mitigation banks associated with one or more wetland areas.

17. A system for environmental field data collection, management and reporting, comprising:
a server platform in network communication with one or more user devices;
wherein the server platform is operable to receive data points from the one or more user devices, and wherein the data points include geolocation data for where each data point was collected;
wherein the data points further include information regarding vegetation, soil, and/or streams proximate to the data points;
wherein the server platform is operable to receive one or more images of vegetation associated with one or more of the data points and utilize artificial intelligence-based matching to identify one or more species of plants in the one or more images of vegetation;
wherein the server platform is operable to generate one or more polygons delineating a project area based on connecting three or more of the data points; and
wherein the server platform utilizes an artificial intelligence-based generation module to automatically generate one or more reports for the project area based on the data points associated with the project area.

18. The system of claim 17, wherein the server platform is operable to receive inputs from the one or more user devices to edit the one or more polygons.

19. The system of claim 17, wherein the server platform includes a database including surveys and/or reports associated with one or more delineated wetland areas.

20. The system of claim 17, wherein the server platform includes a database including one or more mitigation banks associated with each project area.
